(19) United States
(12) Patent Application Publication
(10) Pub. No.: US 2025/0249539 A1
(43) Pub. Date: Aug. 7, 2025

(54) PIN ASSEMBLY, HEAD COVER, BATTERY CELL, BATTERY CELL SET, AND METHOD FOR ASSEMBLING BATTERY CELL

(71) Applicant: Enpower Greentech Inc., San Jose, CA (US)

(72) Inventor: Huanyu Mao, Burnaby (CA)

(73) Assignee: Enpower Greentech Inc., San Jose, CA (US)

(21) Appl. No.: 18/765,165

(22) Filed: Jul. 5, 2024

Related U.S. Application Data
(60) Provisional application No. 63/549,436, filed on Feb. 2, 2024.

(51) Int. Cl. B23K 31/02; H01M 50/15; H01M 50/533; H01M 50/536; H01M 50/538; H01M 50/55; H01M 50/566

(52) U.S. Cl. CPC B23K 31/02; H01M 50/15; H01M 50/533; H01M 50/536; H01M 50/538; H01M 50/55; H01M 50/566

(57) ABSTRACT

The disclosure relates to the technical field of battery cells, in particular to a pin assembly, a head cover, a battery cell, a battery cell set, and a method for assembling a battery cell. The pin assembly comprises a first corner connector which comprises a first plate and a second plate, an included angle being formed between the first plate and the second plate, and the first plate being used to be connected electrically with a terminal on the head cover; and at least one connecting plate, one end of the connecting plate being welded with the second plate, one side of the connecting plate toward the first plate being provided with a first welding zone, and the first welding zone being used to be welded with a tab.

### CROSS-REFERENCE TO RELATED APPLICATIONS

The present disclosure claims the benefits of U.S. Provisional Application No. 63/549,436, filed on Feb. 2, 2024, which is incorporated herein by reference in its entirety.

### TECHNICAL FIELD

The present disclosure relates to the technical field of battery cells, in particular to a pin assembly, a head cover, a battery cell, a battery cell set, and a method for assembling a battery cell.

### BACKGROUND

At present, a tab on a jellyroll needs to be electrically connected to a head cover, which is usually achieved by using a right-angle pin or an adapter, wherein one end of the pin is welded with a terminal on the head cover and the other end of the pin is welded with the tab, so as to finally realize the electrical connection between the tab and the head cover. However, there are some problems in practice. That is, because the tab on the jellyroll is parallel to a larger plane in the jellyroll before assembly, when it is necessary to connect the tab with the pin, the tab is bent to make the tab coincide with connecting plate surfaces placed at two ends of the jellyroll before welding. If the pin and the head cover are welded first in the assembly process of the whole battery cell, then there must have one tab (cathode or anode) that needs to be welded after bending when welding the connecting plate and the tab. The bent tab only has one side connected to the jellyroll, and cannot be effectively supported in the welding process, so welding quality cannot be guaranteed. However, if the pin is connected to the tab first in the assembly process of the whole battery cell, then the head cover needs to be welded with two pins at the same time, while the pins themselves are in a right-angle structure, so one end connected to the head cover cannot be effectively supported in the present process, and the welding quality cannot be guaranteed finally. Moreover, multiple jellyrolls are used, the welding process will be more complicated.

Therefore, it is crucial to put forward a solution for connection between the head cover and the jellyroll.

### SUMMARY

In order to solve the above technical problems or at least partially solve the above technical problems, the present disclosure provides a pin assembly, a head cover, a battery cell, a battery cell set and a method for assembling a battery cell.

In a first aspect, the present disclosure provides a pin assembly, including: a first corner connector, wherein the first corner connector includes a first plate and a second plate, wherein there is an included angle between the first plate and the second plate, and the first plate is used to be connected electrically with a terminal on a head cover; and at least one connecting plate, wherein one end of the connecting plate is welded with the second plate, one side of the connecting plate toward the first plate is provided with a first welding zone, and the first welding zone is used to be welded with a tab.

In some embodiments, one end of the second plate away from the first plate is provided with a connecting section, one side of the connecting section away from the first plate is recessed relative to the second plate to form a welding surface, and the welding surface is welded with one side of the connecting plate toward the first plate.

In some embodiments, one side of the connecting section toward the first plate has a protrusion relative to the second plate.

In some embodiments, a parallel distance from one side surface of the second plate away from the first plate to the welding surface is no less than a thickness of the connecting plate.

In some embodiments, a number of the connecting plate is two, and each of the two connecting plates is respectively used to be welded with homopolar tabs on one side of two jellyrolls.

In some embodiments, a number of the connecting plate is three, and each of the three connecting plates is respectively used to be welded with homopolar tabs on one side of three jellyrolls.

In some embodiments, two adjacent connecting plates of the three connecting plates are integrally arranged.

In some embodiments, the included angle between the first plate and the second plate is 90 degrees.

In a second aspect, the present disclosure also provides a head cover including the pin assembly as described above and further including a head cover sheet, wherein: the head cover sheet is provided with a first end and a second end corresponding to a terminal in a lengthwise direction, one surface of the second end is welded with one surface of the first plate away from the second plate, and the second plate is disposed on one side of the first plate away from the first end.

In some embodiments, a number of the first corner connector is two, and one side of the first end toward the second plate and one side of the second end toward the second plate are respectively welded with the first plate of the corresponding first corner connector.

In some embodiments, the second plate of each of the first corner connectors is welded with two connecting plates, and the two connecting plates are arranged at intervals along a width direction of the head cover sheet.

In some embodiments, the two connecting plates welded on one first corner connector are integrally arranged.

In some embodiments, the second plate of each of the first corner connectors is welded with three connecting plates, and the three connecting plates are arranged at intervals along a width direction of the head cover sheet.

In some embodiments, a second corner connector is further included, wherein the second corner connector includes a third plate and a fourth plate, and there is an included angle between the third plate and the fourth plate; and one side of the first end toward the second corner connector is connected to the third plate, one side of the fourth plate toward the third plate is provided with a second welding zone, and the second welding zone is used to be welded with homopolar tabs on one side of two jellyrolls; and the second plate is welded with two connecting plates, and the two first welding zones of the two connecting plates are used to be correspondingly welded with two tabs on the other sides of the two jellyrolls, respectively.

In some embodiments, the second plate is welded with the two connecting plates, and the two first welding zones of the two connecting plates are used to be correspondingly welded with the two tabs on the other sides of the two jellyrolls, respectively.

In some embodiments, the second plate is welded with three connecting plates, and the two first welding zones of the three connecting plates are used to be correspondingly welded with the two tabs on the other sides of the three jellyrolls, respectively.

In some embodiments, two adjacent connecting plates of the three connecting plates are integrally arranged.

In some embodiments, a positive terminal and a negative terminal are further included, wherein the positive terminal and the negative terminal are respectively arranged at the first end and the second end of the head cover sheet, the negative terminal is connected electrically with the first plate, and the positive terminal is connected electrically with the third plate.

In some embodiments, the included angle between the third plate and the fourth plate is 90 degrees.

In a third aspect, the present disclosure also provides a battery cell including the head cover as described above and further including a cell core, wherein the cell core includes a jellyroll; and one side of the jellyroll along the lengthwise direction of the head cover is provided with a tab, the tab is bent, one side of the tab away from the jellyroll is provided with a third welding zone, and the third welding zone is welded with the first welding zone of the connecting plate.

In some embodiments, the other side of the jellyroll along the lengthwise direction of the head cover is provided with another tab.

In some embodiments, one side of the jellyroll toward the head cover is provided with another tab.

In some embodiments, the cell core includes two jellyrolls, and both ends of the cell core along the lengthwise direction of the head cover sheet are provided with the first corner connectors; wherein the second plate of one first corner connector is provided with two connecting plates, the two connecting plates being correspondingly connected to two tabs on the same side of the two jellyrolls, respectively; and wherein the second plate of another first corner connector is provided with one connecting plate, the connecting plate being connected to two tabs on the another same side of the two cell.

In some embodiments, the cell core includes three jellyrolls, and both ends of the cell core along a lengthwise direction of the head cover sheet are provided with the first corner connectors; and wherein the second plate of one first corner connector is connected to three connecting plates, and the second plate of another first corner connector is provided with two connecting plates, wherein one connecting plate is co-welded with the tabs on the same side of two adjacent jellyrolls.

In some embodiments, the cell core includes three jellyrolls, and both ends of the cell core along a lengthwise direction of the head cover sheet are provided with the first corner connectors; wherein the second plate of one first corner connector is connected to two connecting plates, and one connecting plate is co-welded with the tabs on the same side of one set of two adjacent jellyrolls; and wherein the second plate of another first corner connector is provided with three connecting plates, and one connecting plate is co-welded with the tabs on the other same side of the other set of two adjacent jellyrolls.

In some embodiments, the cell core includes four jellyrolls, and both ends of the cell core along the lengthwise direction of the head cover sheet are provided with the first corner connectors; wherein the second plate of one first corner connector is provided two connecting plates, the two connecting plates being correspondingly welded with the two tabs on the same side of two adjacent jellyrolls, respectively; and the second plate of another first corner connector is provided with three connecting plates, and one connecting plate relative in a middle part is welded with the two tabs on the other same side of the two adjacent jellyrolls in a middle part of the four jellyrolls.

In some embodiments, the cell core includes four jellyrolls, one end of the cell core along one lengthwise direction of the head cover sheet is provided with the first corner connector, and the other end of the cell core is provided with the second corner connector; the second plate of the first corner connector is provided with four connecting plates, and the four connecting plates are welded with the four tabs on the same side of the four jellyrolls, respectively; and the fourth plate of the second corner connector is welded with the four tabs on the other same side of the four jellyrolls.

In some embodiments, the cell core includes four jellyrolls, and both ends of the cell core along the lengthwise direction of the head cover sheet are provided with the first corner connectors; the second plate of one first corner connector is provided with four connecting plates, the four connecting plates being correspondingly welded with the four tabs on the same side of the four jellyrolls, respectively; and the second plate of another first corner connector is provided with two connecting plates, the two connecting plates being correspondingly welded with two tabs on the other same side of two sets of two adjacent jellyrolls, respectively.

In some embodiments, the cell core includes four jellyrolls, and both ends of the cell core along the lengthwise direction of the head cover sheet are provided with the first corner connectors; each of the two first corner connectors is provided with three connecting plates, and one connecting plate located at an edge in the three connecting plates is connected to two tabs on the same side of two adjacent jellyrolls located at an edge in the four jellyrolls; and one of the connecting plates connecting the two tabs is connected to two adjacent jellyrolls of the four jellyrolls, and the other connecting plate is connected to the remaining two jellyrolls of the four jellyrolls.

In some embodiments, a housing and an insulating plate are further included, wherein the cell core is arranged inside the housing; and one side of the insulating plate abuts against the connecting plate and the second plate, and the other side of the insulating plate abuts against an inner wall of the housing.

In a fourth aspect, the present disclosure also provides a battery cell set including a plurality of the battery cells as described above, wherein the plurality of battery cells is connected in parallel.

In a fifth aspect, the present disclosure also provides a method for assembling a battery cell, including: connecting electrically a first plate of a first corner connector with one terminal on a head cover sheet; laying a jellyroll flat, stacking a first tab on a side wall of one side of the jellyroll and a first connecting plate on one first supporting surface, welding the first tab with the first connecting plate, and then bending the first tab to make the first connecting plate be parallel to the side wall on which the first tab is placed; and welding a second plate of the first corner connector with the first connecting plate.

In some embodiments, the method is applied to two jellyrolls, wherein:
the connecting electrically a first plate of a first corner connector with one terminal on a head cover sheet further includes: connecting electrically a first plate of another first corner connector with another terminal on the head cover sheet;
the laying a jellyroll flat, stacking a first tab on a side wall of one side of the jellyroll and a first connecting plate on one first supporting surface, welding the first tab with the first connecting plate, and then bending the first tab to make the first connecting plate be parallel to the side wall on which the first tab is placed further includes: stacking a second tab on a side wall of the other side of the jellyroll and a second connecting plate on one supporting surface, welding the second tab with the second connecting plate, and then bending the second tab to make the second connecting plate be parallel to the side wall on which the second tab is placed;
the welding the second plate of the first corner connector with the first connecting plate further includes: co-welding the two first connecting plates welded on the two first tabs on the same side of the two jellyrolls with the second plate of the first corner connector; and
co-welding the two second connecting plates welded on the two second tabs on the other sides of the two jellyrolls with the second plate of another first corner connector.

In some embodiments, the method is applied to three jellyrolls, wherein:
the connecting electrically a first plate of a first corner connector with one terminal on a head cover sheet further includes: connecting electrically a first plate of another first corner connector with another terminal on the head cover sheet;
the laying a jellyroll flat, stacking a first tab on a side wall of one side of the jellyroll and a first connecting plate on one first supporting surface, welding the first tab with the first connecting plate, and then bending the first tab to make the first connecting plate be parallel to the side wall on which the first tab is placed further includes: stacking a second tab on a side wall of the other side of the jellyroll and a second connecting plate on one supporting surface, welding the second tab with the second connecting plate, and then bending the second tab to make the second connecting plate be parallel to the side wall on which the second tab is placed;
the welding the second plate of the first corner connector with the first connecting plate further includes: co-welding the three first connecting plates welded on the three first tabs on the same side of the three jellyrolls with the second plate of the first corner connector; and
co-welding the three second connecting plates welded on the three second tabs on the other sides of the three jellyrolls with the second plate of another first corner connector.

In some embodiments, the method is applied to two jellyrolls, wherein:
the connecting electrically a first plate of a first corner connector with one terminal on a head cover sheet further includes: connecting electrically a connecting a third plate of a second corner connector with one terminal on the head cover sheet;
before the welding the second plate of the first corner connector with the first connecting plate, the method further includes: vertically placing the head cover sheet to make a fourth plate of the second corner connector be horizontally placed, and placing one side of the two jellyrolls provided with the second tabs opposite to each other, and making the two second tabs of the two jellyrolls and the fourth plate of the second corner connector be stacked on one second supporting surface and welded with each other, and then bending the two jellyrolls relative to the fourth plate of the second corner connector to be parallel to each other; and
the welding the second plate of the first corner connector with the first connecting plate further includes: co-welding the two first connecting plates welded on the two first tabs on the same side of the two jellyrolls with the second plate of the first corner connector.

In some embodiments, after bending the first tab, the laying a jellyroll flat, stacking a first tab on a side wall of one side of the jellyroll and a first connecting plate on one first supporting surface, welding the first tab with the first connecting plate, and then bending the first tab to make the first connecting plate be parallel to the side wall on which the first tab is placed further includes: forming a movable gap between a part of the first tab connected to the first connecting plate and the side wall on which the first tab is placed, the movable gap needing to satisfy:
in step S31, in the process of bending the two jellyrolls relative to the fourth plate of the second corner connector to be parallel to each other, making the two jellyrolls do not interfere with the two first connecting plates, and after the two jellyrolls are rotated to be parallel to each other, further bending the first tab to make the first connecting plate be attached to the second plate of the first corner connector.

In some embodiments, the second supporting surface in step S31 is the same plane as the plane on which the jellyroll is placed in step S2.

In some embodiments, the first supporting surface in step S2 is the same plane as the plane on which the jellyroll is placed.

In some embodiments, before the connecting electrically the first plate of the first corner connector with one terminal on the head cover sheet, the method further includes: forming a welding surface on one side of the second plate of the first corner connector away from the first plate by stamping, extending the welding surface to an edge of one side of the second plate away from the first plate, and welding the welding surface with the first connecting plate.

### BRIEF DESCRIPTION OF THE DRAWINGS

The accompanying drawings herein are incorporated into the specification and constitute a part of the specification, show the embodiments consistent with the present disclosure, and serve to explain the principles of the present disclosure together with the specification.

In order to illustrate the technical solutions in the embodiments of the present disclosure or the prior art more clearly, the drawings to be used in the description of the embodiments or the prior art will be briefly described below. Obviously, those of ordinary skills in the art can also obtain other drawings based on these drawings without going through any creative work.

FIG. 1 is a schematic structural diagram of a pin assembly according to Embodiment 1 of the present disclosure;

FIG. 2 is an axonometric drawing of a first corner connector according to Embodiment 1 of the present disclosure;

FIG. 3 is a side view of the first corner connector according to Embodiment 1 of the present disclosure;

FIG. 4 is a schematic structural diagram showing that both ends of a head cover sheet are pin assemblies, and each pin assembly is provided with two connecting plates, and then is assembled with a cell core formed by two jellyrolls;

FIG. 4a is a schematic structural diagram of a head cover with one end being a first corner connector and the other end being a second corner connector, and including two jellyrolls;

FIG. 5 is an exploded view of a battery cell provided with three jellyrolls;

FIG. 6 is a side view of a state that tabs at opposite ends of one jellyroll are not connected to other parts and not bent;

FIG. 7 is a perspective view of FIG. 6 viewed obliquely from above;

FIG. 8 is a perspective view of FIG. 9 viewed obliquely from above;

FIG. 9 is a side view of a state that two tabs at both ends of one jellyroll are respectively stacked on one connecting plate but not welded and not bent;

FIG. 10 is a side view of a state that two tabs at both ends of one jellyroll are respectively stacked on one connecting plate and welded, but not bent;

FIG. 11 is a side view of a state that the two tabs at both ends of one jellyroll are respectively stacked on one connecting plate and welded, but not bent;

FIG. 12 is an exploded view of three jellyrolls each welded with one connecting plate at both ends;

In FIG. 13: b is a front view showing assembly of one cell core assembled by the three jellyrolls in FIG. 12 with the head cover sheet; a is a left view of FIG. b above; and c is a right view of FIG. b above;

FIG. 14 is an exploded view of a battery cell provided with two jellyrolls;

FIG. 14a is a schematic diagram of a state of the jellyroll with tabs on the opposite sides in the battery cell structure;

FIG. 14b is a schematic diagram of a state of the jellyroll with tabs on the same sides in the battery cell structure;

FIG. 15 is a side view of the second corner connector;

FIG. 16 is an axonometric drawing of FIG. 15;

FIG. 17 is a side view of a state that tabs at opposite ends of one jellyroll are not connected to other parts and not bent;

FIG. 18 is a perspective view of FIG. 17 viewed obliquely from above;

FIG. 19 is a side view of a state that the tab at one end of one jellyroll is stacked on one connecting plate and welded, but not bent;

FIG. 20 is a perspective view of FIG. 19 viewed obliquely from above;

FIG. 21 is a schematic diagram of the tab welded with the connecting plate in FIG. 19 after bending;

FIG. 22 is a schematic diagram showing that two tabs on one side of the jellyroll shown in FIG. 21 without welding a connecting plate are welded on a fourth plate of the second corner connector side by side;

FIG. 23 is a perspective view of FIG. 22 viewed obliquely from above;

In FIG. 24: e is a front view showing assembly of one cell core assembled by the two jellyrolls in FIG. 25 with the head cover sheet; d is a left view of FIG. e above; and f is a right view of FIG. e above;

FIG. 25 is a schematic diagram showing that the two jellyrolls in FIG. 22 both rotate in a direction of the head cover sheet until the two jellyrolls abuts against each other;

FIG. 26 is a schematic structural diagram showing that both ends of a single jellyroll are provided with a connecting plate;

FIG. 27 is a schematic structural diagram showing a single jellyroll provided with a connecting plate at one end and provided with a second corner connector at the other end;

FIG. 28 is a schematic structural diagram showing two jellyrolls provided with a connecting plate at one end and provided with a second corner connector at the other end;

FIG. 29 is a schematic structural diagram showing that both ends of two jellyrolls are both provided with a connecting plate and two tabs at one end are connected to the same connecting plate;

FIG. 30 is a schematic structural diagram showing that both ends of two jellyrolls are both provided with a connecting plate and tabs at each end are correspondingly connected to one connecting plate, respectively;

FIG. 31 is a schematic structural diagram showing that both ends of three jellyrolls are both provided with a connecting plate and tabs at each end are correspondingly connected to one connecting plate, respectively;

FIG. 32 is a schematic structural diagram showing that both ends of three jellyrolls are both provided with a connecting plate and tabs at one end are correspondingly connected to one connecting plate, respectively, while two tabs at the other end share one connecting plate;

FIG. 33 is a schematic structural diagram showing that both ends of three jellyrolls are both provided with a connecting plate and two tabs of the jellyrolls co-connected to one connecting plate exist at both ends of the three jellyrolls;

FIG. 34 is a schematic structural diagram showing three jellyrolls provided with a connecting plate at one end and provided with a second corner connector at the other end;

FIG. 35 is a schematic structural diagram showing that one end of four jellyrolls are provided with two connecting plates, and the two connecting plates are both connected to two connecting plates at the same time, the other end of the four jellyrolls are provided with three connecting plates, and the tabs corresponding to the two jellyrolls in the middle share one connecting plate;

FIG. 36 is a schematic structural diagram showing that tabs at one end of four jellyrolls are correspondingly provided with a connecting plate, respectively; and tabs at the other end of the four jellyrolls are provided with a second corner connector;

FIG. 37 is a schematic structural diagram showing that tabs at one end of four jellyrolls are correspondingly provided with a connecting plate, respectively; and the two tabs located above at the other end of the four jellyrolls are co-connected to one connecting plate, while the two tabs located below are co-connected to one connecting plate; and

FIG. 38 shows that in four tabs at one end of four jellyrolls, the two tabs located above are co-connected to one connecting plate, while the two tabs located below are correspondingly connected to one connecting plate, respectively; and in four tabs at the other end, the two tabs located below are co-connected to one connecting plate, while the two tabs located above are each correspondingly connected to one connecting plate.

Wherein:
1. first corner connector; 10. first plate; 11. second plate; 110. welding surface; 111. connecting section; 112. protrusion; 2. connecting plate; 20. first welding zone; 3. jellyroll; 30. tab; 300. third welding zone; 301. first jellyroll; 302. second jellyroll; 303. third jellyroll; 304. fourth jellyroll; 4. head cover; 40. head cover sheet; 41. first end; 42. second end; 5. second corner connector; 50. third plate; 51. fourth plate; 510. second welding zone; and 6. insulating plate.

### DETAILED DESCRIPTION

In order to better understand the above objects, features and advantages of the present disclosure, the solutions to the present disclosure will be further described below. It should be noted that, in case of no conflict, the embodiments in the present disclosure and the features in the embodiments may be arbitrarily combined with each other.

In the following description, many specific details are set forth in order to fully understand the present disclosure, but the present disclosure may be practiced in other ways than those described herein. Obviously, the embodiments described in the specification are merely a part of, rather than all the embodiments of the present disclosure.

Unless otherwise defined, all the technical and scientific terms used herein have the same meaning as commonly understood by those skilled in the technical field of the present disclosure. The terms used herein are for the purpose of describing the specific embodiments only and are not intended to limit the present disclosure. Furthermore, the terms “including” and “provided with” and any variations thereof in the specification and claims as well as the above drawings of the present disclosure are intended to cover non-exclusive inclusion.

In the description of the embodiments of the present disclosure, the technical terms “first”, “second”, etc. are used to distinguish different objects, and cannot be understood as indicating or implying relative importance, or implicitly indicating the number, specific order or primary-secondary relationship of the indicated technical features.

Reference in the specification to “an embodiment” means that a particular feature, structure, or characteristic described in connection with the embodiment may be included in at least one embodiment of the present disclosure. The appearances of the phrase in various places in the specification are not necessarily all referring to the same embodiment, nor are separate or alternative embodiments mutually exclusive of other embodiments. It is to be expressly and implicitly understood by those skilled in the art that the embodiments described herein may be combined with other embodiments without conflict.

In the description of the embodiments of the present disclosure, the term “and/or” is used for describing an association relationship of associated objects, indicating that there may be three relationships, for example, “A and/or B” may indicate: these three cases including only A, both A and B, and only B. In addition, the character “/” herein generally indicates that the contextual associated objects are of an “or” relationship.

In the description of the embodiments of the present disclosure, the term “multiple” refers to more than two (including two), similarly, “multiple sets” refers to more than two sets (including two sets, and “multiple pieces” refers to more than two pieces (including two pieces).

In the description of the embodiments of the present disclosure, the orientation or positional relationships indicated by the technical terms “center”, “longitudinal”, “transversal”, “length”, “width”, “thickness”, “up”, “down”, “front”, “back”, “left”, “right”, “vertical”, “horizontal”, “top”, “bottom”, “inside”, “outside”, “clockwise”, “anticlockwise”, “axial”, “radical”, “circumferential” and the like are orientation or positional relationships based on the drawings, which are only for convenience and simplification of the description of the present disclosure, but are not intended to indicate or imply that the indicated device or element must have a specific orientation, be constructed and operated in a specific orientation, and thus, cannot be understood as a limitation to the present disclosure.

In the description of the embodiments of the present disclosure, unless expressly stipulated and defined otherwise, the technical terms such as “installation”, “connected”, “connection”, “fixing”, and the like, should be understood broadly, for example, the connection may be fixed connection, or detachable connection or integral connection; may be mechanical connection, and may also be electrical connection; and may be directly connected, may also be indirectly connected through an intermediate medium, and may also be internal communication of two elements or interaction relationship of two elements. The specific meaning of the above terms in the embodiments of the present disclosure can be understood in a specific case by those of ordinary skills in the art.

The first corner connector in the pin assembly provided by the present disclosure for connecting the head cover and the connecting plate for connecting the jellyroll are arranged separately, which is very flexible in the welding process; with respect to a jellyroll with the tab on the opposite side, welding strength of the tab is met by selecting the pin assembly provided by the present disclosure at one end of the jellyroll; and meanwhile, under the action of the connecting plate, a connecting area between the connecting plate and the tab and present head cover sheet is larger, which further improves current transmission efficiency, thereby improving a specific power of the battery cell, and improving performances of the battery.

In addition, the battery cell with the pin assembly has a more compact structure, thus having a greater energy density.

Meanwhile, the present disclosure also provides the method for assembling the battery cell; during assembly, the tab on one side of the jellyroll is connected to the terminal on the head cover sheet through the pin assembly, and the tab on the other side of the jellyroll is connected to the terminal through the first corner connector or the second corner connector; with respect to the jellyroll with the tab on the opposite side, the connections respectively between the connecting plate and the tab as well as between the connecting plate and the terminal can be better realized, and connection strength can be ensured at the same time, thus further improving the performances of the final battery.

### Embodiment 1

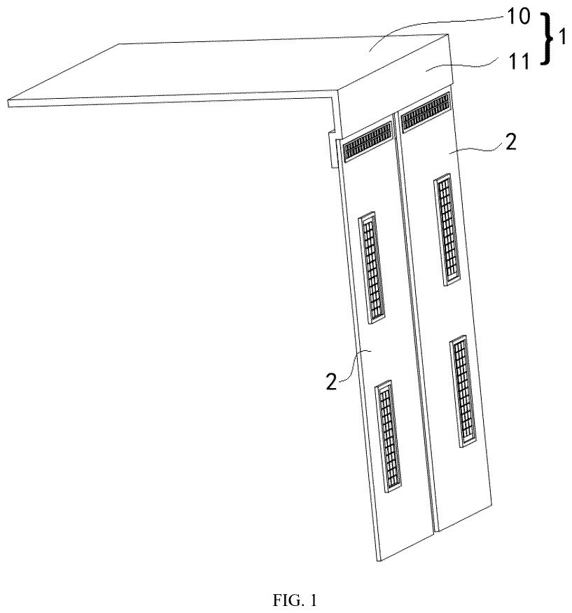

As shown in FIGS. 1-3, in a first aspect, the present disclosure provides a pin assembly, including: a first corner connector 1, wherein the first corner connector 1 includes a first plate 10 and a second plate 11. There is an included angle between the first plate 10 and the second plate 11, and the first plate 10 is used to be connected electrically with a terminal on a head cover 4.

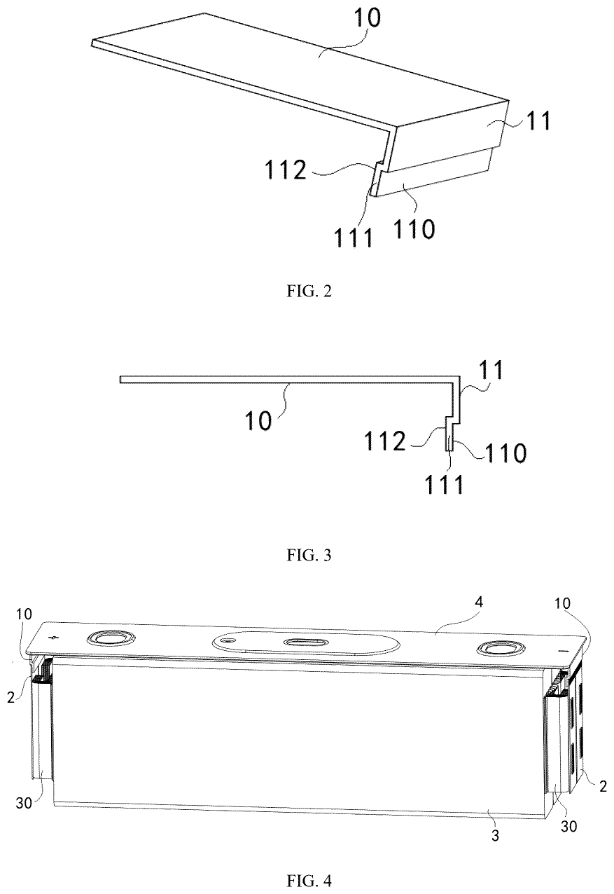

Referring to FIGS. 2 and 3 in detail, the first corner connector 1 has a plate (sheet) structure, and after being bent on both sides forming a thickness thereof, the first plate 10 and the second plate 11 with a set angle with each other are formed for connecting the terminal in the head cover 4 and a tab 30 in a jellyroll 3, respectively.

Referring to FIG. 3 synchronously, taking a state of the first corner connector 1 shown in the figure as an example, a horizontal section is designated as the first plate 10, and the first plate 10 is used to be connected electrically with the terminal in the head cover 4. A vertical section is designated as the second plate 11, and the second plate 11 is used to be electrically connected to the tab 30 in the jellyroll 3.

It should be noted that the first plate 10 and the second plate 11 only distinguish two sections of the first corner connector 1 that are angled to each other and should not be understood as the only corresponding relationship with related features. For example, in some embodiments, the two ends of the first corner connector 1 that are bent to each other may also be named opposite to the aforementioned names, but the specific correspondence relationship should be based on an actual structure.

In some embodiments, the first corner connector 1 is integrally formed, and the bending process can be formed by a related bending device according to a set program.

The first plate 10 and the second plate 11, which are angled with each other, can still play a certain connecting role when the head cover 4 and the side of the jellyroll 3 where the tab 30 is arranged are not aligned. For example, when the head cover 4 is arranged above the jellyroll 3, while the tab 30 in the jellyroll 3 is located at a side surface of the jellyroll 3, the tab 30 can be directly or indirectly connected to the terminal through the first corner connector 1 in this case, which makes the connection between the jellyroll 3 and the tab 30 on the head cover 4 more flexible. Especially when the jellyroll 3 with tabs on opposite sides 30, under the action of the first corner connector 1, the head cover 4 may be placed on a plane of one jellyroll 3 separated by two tabs 30, so that a structure of the battery cell is more compact, thus having greater energy density.

Referring back to FIG. 1, the pin assembly also includes at least one connecting plate 2. One end of the connecting plate 2 is welded to the second plate 11, and one side of the connecting plate 2 toward the first plate 10 is provided with a first welding zone 20. The first welding zone 20 is used to be connected to the tab 30.

The connecting plate 2 has a plate (sheet) structure, one section of which is used to be welded with the second plate 11 in the first corner connector 1, while the other section of the connecting plate is used to be welded with the tab 30 in the jellyroll 3. The connecting plate is used for conducting electricity. Therefore, in this embodiment, whether the connecting plate is welded with the second plate 11 or the tab 30, the welding is realized through a side wall of the connecting plate with a large area. Therefore, when the connecting plate and the first corner connector 1 are in a use state, the connecting plate is always welded with the tab 30 toward one side surface of the first plate 10.

Meanwhile, to ensure welding strength and electrical transmission performance of the tab 30 and the connecting plate 2, both of the two are welded in a certain zone. That is, the first welding zone 20 set on the connecting plate 2.

When the tab 30 in the jellyroll 3 is connected to the terminal on the head cover 4 through the pin assembly above, the tab 30 can be flexibly welded with the connecting sheet without being affected by a state of the tab 30 (before or after bending), while the first corner connector 1 can be flexibly welded with a head cover sheet 40 in the head cover 4 without being affected by the state of the tab 30 (before or after bending), and finally the electric connection between the tab 30 and the terminal can be realized by ensuring the connecting plate 2 and the plate in the first corner connector 1.

In addition, because the tab 30 is soft and easy to deform, the requirements for welding between any member and the tab 30 are higher than requirements on welding between the connecting plate 2 and the second plate 11. Therefore, under the action of the connecting plate 2 a posture of which is not restricted, the tab 30 can be welded with the connecting plate 2 before the tab is bent, so that the tab has a better welding posture, thus ensuring high connection strength and excellent conductivity of the two after in the use state finally.

In some embodiments, one end of the second plate 11 away from the first plate 10 is provided with a connecting section 111, one side of the connecting section 111 away from the first plate 10 is recessed relative to the second plate 11 to form a welding surface 110, and the welding surface 110 is welded with one side of the connecting plate 2 toward the first plate 10.

Referring to FIGS. 2 and 3, one end of the second plate 11 away from the first plate 10 is the connecting section 111. In this embodiment, the connecting section 111 is the section connected to the connecting plate 2. In order to avoid a stacking phenomenon after two plate (sheet)-like second plates 11 and a side wall of the connecting plate 2 are welded to each other to increase occupied space of the whole battery cell, a depressed section is formed on one side of the connecting section 111 away from the first plate 10 relative to the second plate 11 itself, and the welding surface 110 is formed on the depressed section. When the connecting plate 2 is connected to the second plate 11, it is actually that the welding surface 110 in the second plate 11 is welded with the side wall of the connecting plate 2, thus avoiding unnecessary stacking and reducing the energy density of the whole battery cell.

The depression on the second plate 11 can be formed by pressing.

In some still further embodiments, one side of the connecting section 111 toward the first plate 10 has a protrusion 112 relative to the second plate.

Referring to FIG. 3, based on the welding surface 110 formed by depression, one side of the connecting section 111 toward the first plate 10 forms the protrusion 112 relative to the second plate 11. From the structural strength point of view, the formation of the protrusion 112 can increase a thickness of the connecting section 111, so that the welding surface 110 thereon has better support strength when welded with the connecting plate 2, so as to avoid bending of the connecting section 111 during the welding process and reduce On the basis of the recessed welding surface 110, the side of the connecting section 111 facing the first plate 10 forms a protrusion 112 relative to the second plate 11. From the structural strength point of view, the formation of the protrusion 112 can increase the thickness of the connecting section 111, so that the welding surface 110 on it has better support strength when the connecting plate 2 is welded, so as to avoid the bending of the connecting section 111 during the welding process and reduce a probability that the connecting section 111 will bend due to other unexpected factors in a subsequent assembly process. From the point of electrical conductivity, the existence of the protrusion 112 inevitably increases a transverse base area of the whole second plate 11 in a current flow direction, thus ensuring the second plate to have better electrical transmission performance.

In some embodiments, a parallel distance from one side surface of the second plate 11 away from the first plate 10 to the welding surface 110 is not less than a thickness of the connecting plate 2.

Referring to FIGS. 1 and 3, in combination with the above, the setting of the depression aims to avoid stacking of the connecting plate 2 and the second plate 11. Therefore, in this embodiment, the parallel distance from the one side surface of the second plate 11 away from the first plate 10 to the welding surface 110 is no less than the thickness of the connecting plate 2, so as to ensure that after the connecting plate 2 is welded with the welding surface 110 formed by depression, one side surface of the connecting plate away from the welding surface 110 is always closer to the welding surface 110 than one side surface of the second plate 11 back to the first plate 10, so as to avoid a situation that the battery cell is too large to reduce the energy density due to stacking.

It should be noted that the head cover sheet 40 in the head cover 4, a right-angle connector (which functions similarly to the first corner connector 1 in the present disclosure) and a housing usually have a strict assembly relationship, so it is crucial to ensure that the size of the second plate 11 in the first corner connector 1 is not affected. Therefore, from the assembly point of view, the parallel distance from one side surface of the second plate 11 away from the first plate 10 to the welding surface 110 no less than the thickness of the connecting plate 2 can still ensure smooth execution of a subsequent assembly process and avoid other related interference problems.

In some embodiments, the number of the connecting plate 2 is two, and each of the two connecting plates is respectively used to be welded with homopolar tabs 30 on one side of two jellyrolls 3.

In fact, there are two connecting plates 2, and the connecting plates 2 are respectively welded with the homopolar tabs 30 on the same sides in the two jellyrolls 3. The two connecting plates 2 are arranged at intervals along an arrangement direction of the two jellyrolls 3. Similarly, when the number of the connecting plates 2 is other, the arrangement of the connecting plates 2 in other number is the same as that of two jellyrolls 3, all of which are based on the arrangement of the jellyrolls 3 in the current number.

In some embodiments, the number of the connecting plate 2 is three, and each of the three connecting plates is respectively used to be welded with homopolar tabs 30 on one side of three jellyrolls 3.

In some embodiments, the number of the connecting plate 2 may also be three.

In some embodiments, two adjacent connecting plates 2 of the three connecting plates 2 are integrally arranged. That is, the two integrally arranged connecting plates 2 are actually one connecting plate 2, on which the tabs 30 on the same side of the two jellyrolls 3 are directly welded.

Alternatively, the included angle between the first plate 10 and the second plate 11 is 90 degrees.

In the first corner connector 1, the included angle between the first plate 10 and the second plate 11 is 90 degrees to adapt to a traditional square aluminum shell battery cell, and meanwhile, make the battery cell more compact in structure and ensure an energy density thereof.

In a second aspect, the present disclosure also provides a head cover including the pin assembly as described above and further includes a head cover sheet 40, wherein: the head cover sheet 40 is provided with a first end 41 and a second end 42 corresponding to the terminal in a lengthwise direction, one surface of the second end 42 is welded with one surface of the first plate 10 away from the second plate 11, and the second plate 11 is disposed on one side of the first plate 10 away from the first end 41.

The head cover sheet 40 has a plate (sheet) structure and has a certain length, and the first end and the second end are provided corresponding to two terminals in the lengthwise direction. One side surface of the second end 42 forming a thickness of the head cover sheet 40 is welded with one side surface of the first plate 10 away from the second plate 11 to ensure welding strength and electric transmission performance of the two.

In practice, a zone formed by the included angle between the first plate 10 and the second plate 11 is a position of the jellyroll 3. Therefore, in order to ensure that the zone is also the zone surrounded by the head cover sheet 40 and the second plate 11, the second plate 11 is defined to be located on one side of the first plate 10 away from the second end, so that the zone surrounded by the first plate 10 and the second plate 11 is the same as the zone surrounded by the head cover sheet 40 and the second plate 11, so as to ensure that the structure of the finally formed battery cell is more compact, which can be better adapted to the aluminum shell battery cell meanwhile.

In some embodiments, the number of the first corner connector 1 is two, and one side of the first end 41 toward the second plate 11 and one side of the second end 42 toward the second plate 11 are respectively welded with the first plate 10 of the corresponding first corner connector.

When both ends of the head cover sheet 40 are the first corner connectors 1, the head cover 4 can be welded with the tab 30 through the connecting plates 2 in the pin assemblies at both ends in the assembly process. Finally, the connecting plates 2 are connected to the corresponding second plates 11, so as to ensure that the tabs 30 at the two opposite sides of the jellyroll 3 can get better welding effect under the action of the connecting plates 2 and ensure the final electric transmission performance.

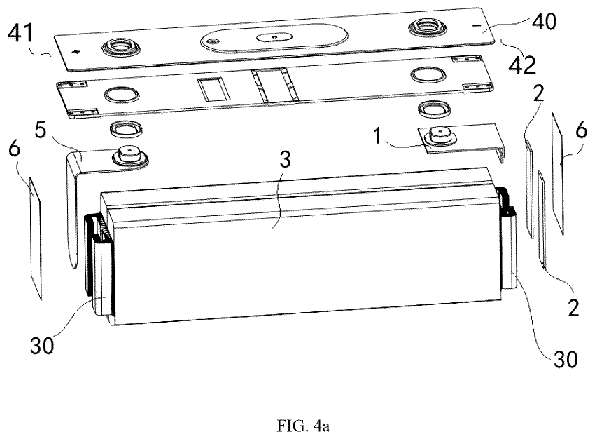

For example, referring to FIG. 4 in detail, as shown, both ends of the head cover sheet 40 are pin assemblies when two jellyrolls 3 are provided.

In some embodiments, the second plate 11 of each of the first corner connectors 1 is welded with two connecting plates 2, and the two connecting plates 2 are arranged at intervals along a width direction of the head cover sheet 40. Specifically, when both ends of the head cover sheet 4 are provided with the first corner connectors 1, each first corner connector 1 may include two connecting plates 2.

In some embodiments, the two connecting plates 2 welded on one first corner connector 1 are integrally arranged. Specifically, the two connecting plates 2 located at a positive electrode, i.e., the two connecting plates 2 may be integrally arranged, that is, one connecting plate 2 is commonly connected to the tabs 30 at the same side of the two jellyrolls 3.

In some still further embodiments, the second plate 11 of each of the first corner connectors 1 is welded with three connecting plates 2 are welded to, and the three connecting plates 2 are arranged at interval along a width direction of the head cover sheet 40.

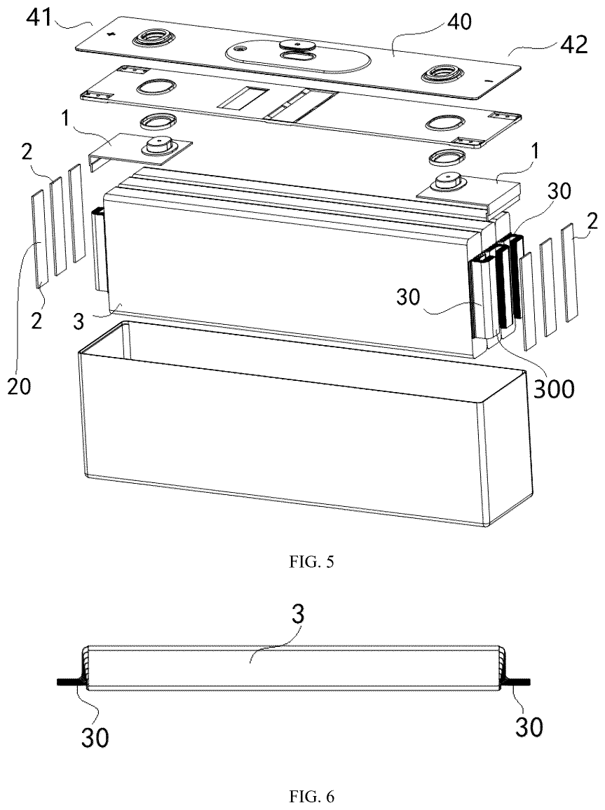

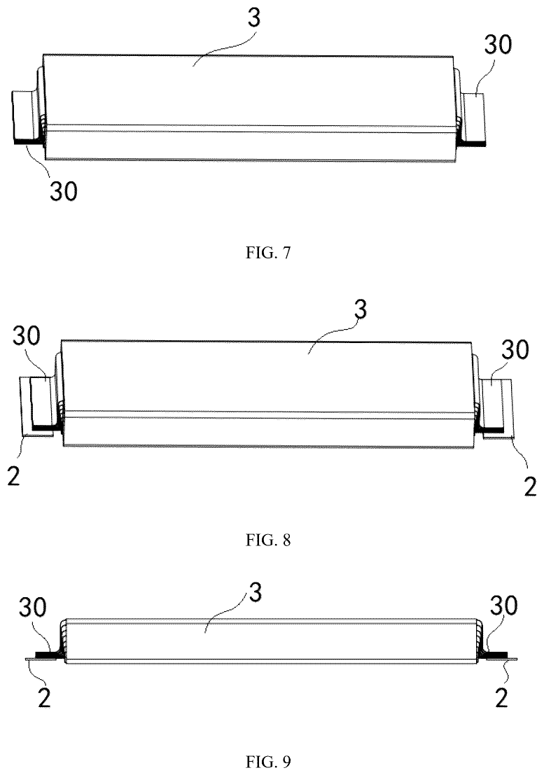

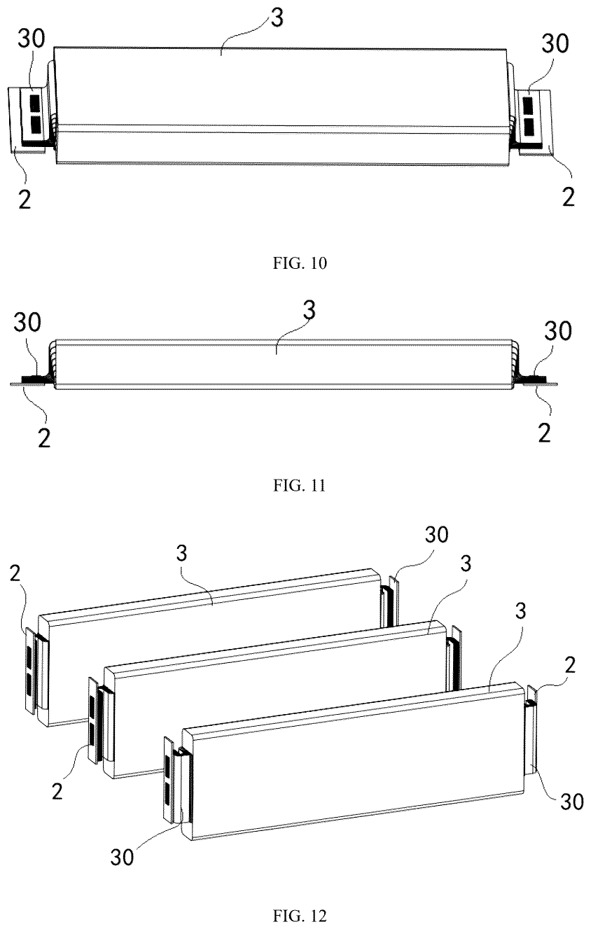

Referring to the content shown in FIG. 5 in detail, on the basis that both ends of the head cover sheet 40 are provided with a pin assembly, each pin assembly includes three connecting plates 2. The three connecting plates 2 are arranged in the same plane and arranged at intervals along the width direction of the head cover sheet 40. It should be understood that when each pin assembly includes three connecting plates 2, a number of corresponding jellyrolls 3 is also three.

Under the action of the pin assembly, no matter how many jellyroll 3 there are, the corresponding connecting plate 2 may be welded before the tab 30 is bent, so as to ensure a welding effect between the connecting plate 2 and the tab 30, and avoid a limitation caused by connecting (welding) the head cover sheet 40 and the tab 30 directly through a right-angle connector (the function of which is related to the first corner connector 1).

In some embodiments, a second corner connector 5 is further included, wherein the second corner connector 5 includes a third plate and a fourth plate, and there is an included angle between the third plate and the fourth plate. One side of the second end toward the second corner connector 5 is connected to the third plate, one side of the fourth plate toward the third plate is provided with a second welding zone 510, and the second welding zone 510 is used for welding with homopolar tabs 30 on one side of two jellyrolls 3. The second plate 11 are welded with two connecting plates 2, and the two first welding zones 510 of the two connecting plates 2 are correspondingly welded with two tabs 30 on the other sides of the two jellyrolls 3, respectively.

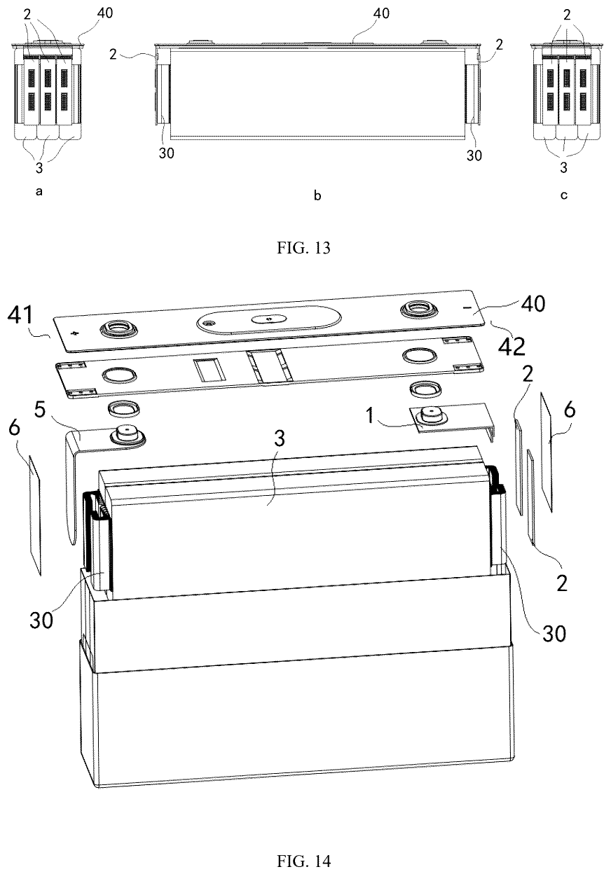

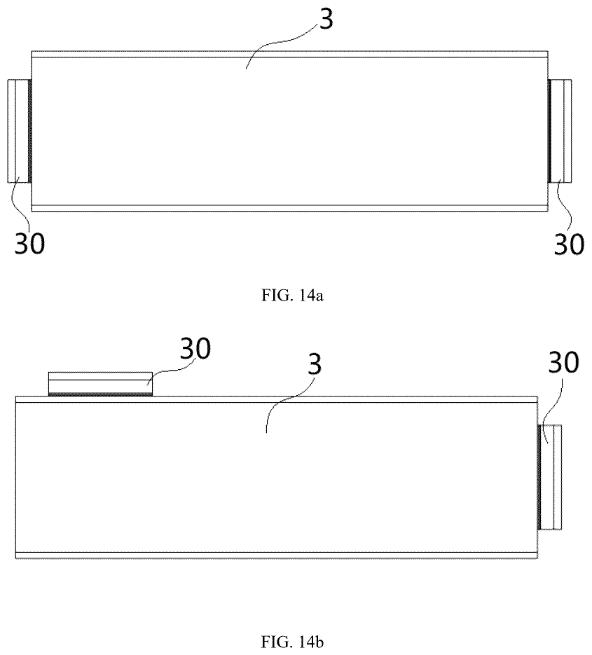

Referring to FIG. 14, an exploded view of the battery cell structure when the head cover sheet 40 has only one end provided with the pin assembly is shown. The number of the jellyrolls 3 is two. In addition, referring to FIG. 4a, a schematic structural diagram of the head cover in this embodiment is shown.

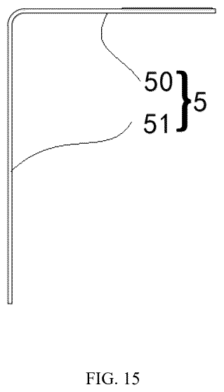

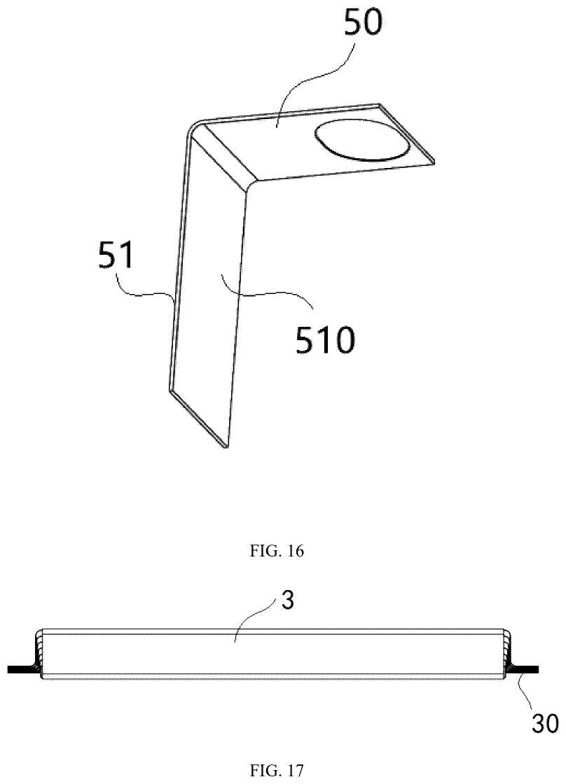

Referring to FIGS. 15 and 16, a structural schematic diagram of the second corner connector 5 is shown. As illustrated, the second corner connector 5 includes a third plate and a fourth plate with an included angle with each other. On the basis of connecting the first end with the first plate 10, the second end is connected to the third plate in the second corner connector 5, a second welding zone 510 is arranged on one side of the fourth plate toward the third plate, and the second welding zone 510 is used to be welded with homopolar tabs 30 on one side of the two jellyrolls 3. Correspondingly, the pin assembly arranged in the pin assembly at one end includes two connecting plates 2, and the second welding zones 510 in the connecting plates 2 are each correspondingly welded with homopolar tabs 30 on the other sides of the two jellyrolls 3.

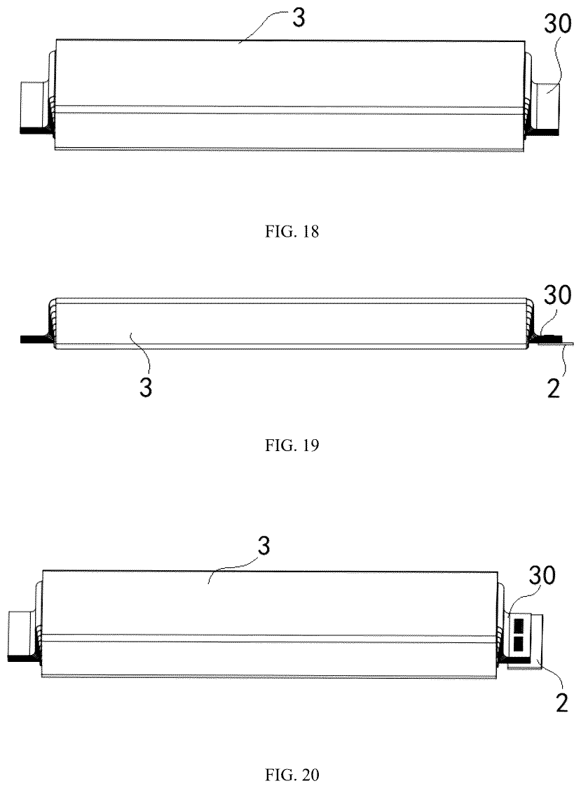

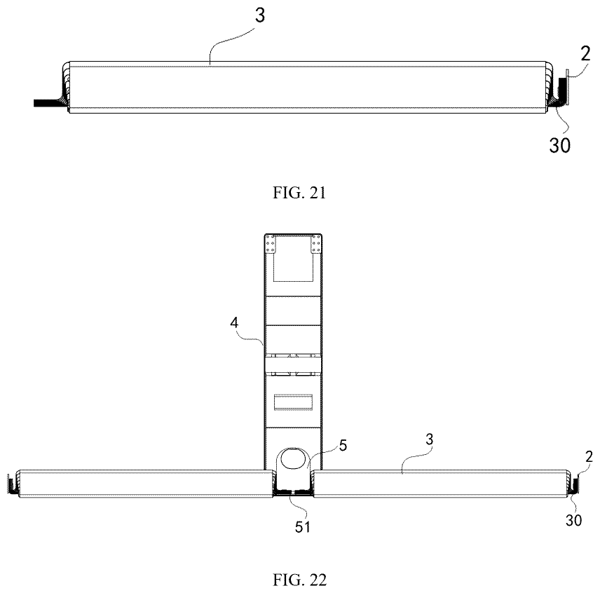

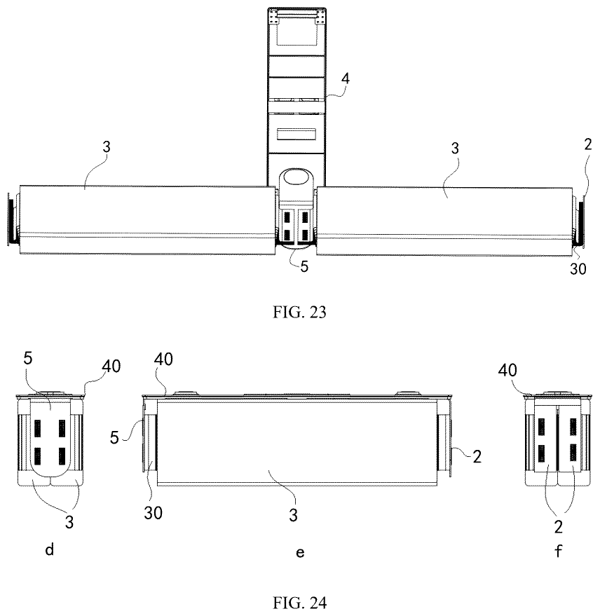

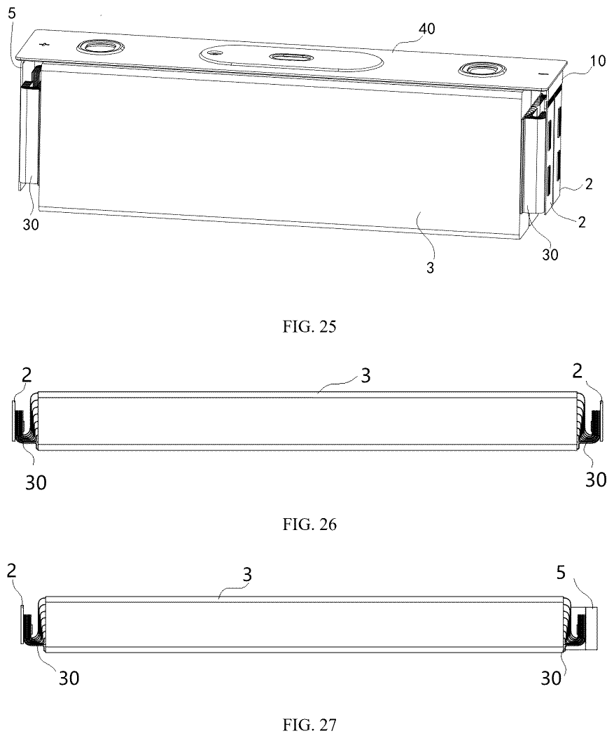

Referring to FIG. 17 to FIG. 25, an assembly process in which the first end of the head cover sheet 40 is the first corner connector 1, the second end is the second corner connector 5, and the number of the jellyrolls 3 is two will be exemplified.

In some embodiments, two connecting plates 2 are welded on some second plates 11, and the two first welding zones 20 of the two connecting plates 2 are used to be correspondingly welded with two tabs 30 on the other sides of the two jellyrolls 3, respectively.

In some embodiments, the second plate 11 is welded with three connecting plates 2, and the two first welding zones 20 of the three connecting plates 2 are used to be correspondingly welded with two tabs 30 on the other sides of the three jellyrolls 3, respectively.

In some embodiments, two adjacent connecting plates 2 of the three connecting plates 2 are integrally arranged, that is, the integrally arranged connecting plates 2 are wider, and are connected to two tabs 30 on the same side of the two jellyrolls 3.

In some still further embodiments, a positive terminal and a negative terminal are further included, wherein the positive terminal and the negative terminal are respectively arranged at the first end 41 and the second end 42 of the head cover sheet 40, the negative terminal is connected electrically with the first plate 10, and the positive terminal is connected electrically with the third plate 50.

Referring to FIG. 14, the first end 41 of the head cover sheet 40 is provided with the positive terminal, and the second end 42 of the head cover sheet 40 is provided with the positive terminal. Correspondingly, the negative terminal is connected electrically with the first plate 10 provided at the second end 42, and the positive terminal is connected electrically with the third plate 50 provided at the first end 41 to achieve final output in the jellyroll 3.

In some embodiments, the included angle between the third plate 50 and the fourth plate 51 is 90 degrees.

Referring to FIG. 15, the included angle between the third plate 50 and the fourth plate 51 in the second corner connector 5 is 90 degrees to adapt to the traditional square aluminum shell battery cell, and meanwhile, make the battery cell more compact in structure and ensure an energy density thereof.

In a third aspect, the present disclosure also provides a battery cell including the head cover 4 as described above and further including a cell core, wherein the cell core includes a jellyroll 3, and one side of the jellyroll 3 along the lengthwise direction of the head cover 4 is provided with a tab 30, the tab 30 is bent, one side of the tab 30 away from the jellyroll 3 is provided with a third welding zone 300, and the third welding zone 300 is welded with the first welding zone 20 of the connecting plate 2.

For example, referring to FIG. 5 or FIG. 14, a plurality of jellyrolls 3 are attached together to form the cell core. When the number of the jellyrolls 3 is two, one side of the cell core along the lengthwise direction of the head cover 4 is provided with two tabs 30, and when the number of the jellyrolls 3 is three, one side of the cell core along the lengthwise direction of the head cover 4 is provided with three tabs 30.

Referring to a state formed after the tab 30 is bent, a third welding zone 300 is provided on one side away from the cell core, and the third welding zone 300 is welded to the first welding zone 20 of the connecting plate 2.

It should be noted that the greater the overlapping area of the third welding zone 300 and the first welding zone 20 is, the greater the connection strength between the tab 30 and the connecting plate 2, and the better the electrical transmission performance.

In some embodiments, the other side of the jellyroll 3 along the lengthwise direction of the head cover 4 is provided with another tab 30.

Referring to FIG. 14a, when there is one tab 30 on one side of the jellyroll 3 along the lengthwise direction of the head cover 4, there is also one tab 30 on the corresponding other side. That is, the head cover 4 mentioned above is also suitable for a battery cell with tabs 30 on opposite sides in the cell core.

In some other embodiments, one side of the jellyroll 3 toward the head cover sheet 40 is provided with one tab 30.

Referring to FIG. 14b, when there is one tab 30 on one side of the jellyroll 3 along the lengthwise direction of the head cover 4, one side of the jellyroll 3 toward the head cover sheet 40 is provided with one tab 30. That is, the head cover 4 mentioned above is also suitable for only the tab 30 of one electrode (positive or negative) being arranged on one side along the lengthwise direction of the head cover sheet 40, and the tab 30 of the other electrode being arranged on one side of the jellyroll 3 toward the head cover sheet 40.

In some embodiments, the cell core includes two jellyrolls 3, and both ends of the cell core along the lengthwise direction of the head cover sheet 40 are provided with the first corner connectors 1. The second plate 11 of one first corner connector 1 is provided with two connecting plates 2, the two connecting plates 2 being correspondingly connected to two tabs 30 on the same side of two jellyrolls 3, respectively. The second plate 11 of another first corner connector 1 is provided with one connecting plate 2, the connecting plate 2 being connected to two tabs 30 on the other same side of the two jellyrolls 3.

In some embodiments, the cell core includes three jellyrolls 3, and both ends of the cell core along the lengthwise direction of the head cover sheet 40 are provided with the first corner connectors 1. The second plate 11 of one first corner connector 1 is provided with three connecting plates 2. The second plate 11 of another first corner connector 1 is provided with two connecting plates 2, wherein one connecting plate 2 is co-welded with the tabs 30 on the same side of two adjacent jellyrolls 3.

In some embodiments, the cell core includes three jellyrolls 3, and both ends of the cell core along the lengthwise direction of the head cover sheet 40 are provided with the first corner connectors 1. The second plate 11 of one first corner connector is provided with two connecting plates 2, and one connecting plate 2 is co-welded with the tabs 30 on the same side of one set of two adjacent jellyrolls 3. The second plate 11 of another first corner connector 1 is provided with two connecting plates 2, and one connecting plate 2 is co-welded with the tabs 30 on the other same side of the other set of two adjacent jellyrolls 3.

In some embodiments, the cell core includes four jellyrolls 3, and both ends of the cell core along the lengthwise direction of the head cover sheet 40 are provided with the first corner connectors 1. The second plate 11 of one first corner connector 1 is provided with two connecting plates 2, the two connecting plates 2 being co-welded with the two tabs 30 on the same side of two adjacent jellyrolls 3, respectively. The second plate 11 of another first corner connector 1 is provided with three connecting plates 2, and one connecting plate 2 in the middle part is welded with the two tabs 30 on the same side of the two adjacent jellyrolls 3 in the middle part of the four jellyrolls 3.

In some embodiments, the cell core includes four jellyrolls 3, one end of the cell core along the lengthwise direction of the head cover sheet 40 is provided with the first corner connector 1, and the other end of the cell core is provided with the second corner connector 5. The second plate 11 of the first corner connector 1 is provided with four connecting plates 2, and the four connecting plates 2 are welded with the four tabs 30 on the same side of the four jellyrolls 3, respectively. The fourth plate 51 of the second corner connector 5 is welded with the four tabs 30 on the other same side of the four jellyrolls 3.

In some embodiments, the cell core includes four jellyrolls 3, and both ends of the cell core along the lengthwise direction of the head cover sheet 40 are provided with the first corner connectors 1. The second plate 11 of one first corner connector 1 is provided with four connecting plates 2, the four connecting plates 2 being correspondingly welded with the four tabs 30 on the same side of the four jellyrolls 3, respectively. The second plate 11 of another first corner connector 1 is provided with two connecting plates 2, and the two connecting plates 2 are correspondingly welded with two tabs 30 on the other same side of two sets of two adjacent jellyrolls 3, respectively.

In some embodiments, the cell core includes four jellyrolls 3, and both ends of the cell core along the lengthwise direction of the head cover sheet 40 are provided with the first corner connectors 1. Each of the two first corner connectors 1 is provided with three connecting plates 2, and one connecting plate 2 located at an edge of the three connecting plates 2 is connected to two tabs 30 on the same side of two adjacent jellyrolls 3 located at an edge of the four jellyrolls 3. One of the connecting plates 2 connecting the two tabs 30 is connected to two adjacent jellyrolls 3 of the four jellyrolls 3, and the other connecting plate 2 is connected to the remaining two jellyrolls 3 of the four jellyrolls 3.

In some embodiments, a housing and an insulating plate 6 are further included, wherein the cell core is arranged inside the housing. One side of the insulating plate 6 abuts against the connecting plate 2 and the second plate 11, and the other side of the insulating plate 6 abuts against the inner wall of the housing.

In addition, when one end of the head cover sheet 40 in the battery cell is provided with the first corner connector 1, and the other end of the head cover sheet is provided with the second corner connector 5, one side of one of the insulating plates 6 may also abut against one side of the fourth plate 51 away from the cell core. The insulating plate 6 is used for insulating the tab 30 from the housing to avoid electric energy losses.

In a fourth aspect, the present disclosure provides a battery cell set including a plurality of battery cells as described above, wherein the plurality of battery cells are connected in parallel.

On the premise of ensuring a compact structure of the whole battery pack, that is, meeting contour requirements, the arrangement of the plurality of battery cells in this disclosure is not limited.

In the second corner connector 5, an edge of the fourth plate 51 may be in an arc transition shape or in other shapes such as a rectangle, and the specific shape is not limited.

### Embodiment 2

In a fifth aspect, the present disclosure also provides a method for assembling a battery cell, including the following steps.

S1. A first plate 10 of a first corner connector 1 is connected electrically with one terminal on a head cover sheet 40.

S2. A jellyroll 3 is laid flat. A first tab on a side wall of one side of the jellyroll 3 and a first connecting plate are stacked on one first supporting surface. The first tab is welded with the first connecting plate, and then the first tab is bent so that the first connecting plate is parallel to the side wall on which the first tab is placed.

The “first tab” is equivalent to one tab 30 on one side of a single jellyroll 3, which is used to distinguish the tabs 30 at both ends of the jellyroll 3.

S3. A second plate 11 of the first corner connector 1 is welded with the first connecting plate.

The execution orders of step S1 and step S2 are interchangeable, and step S3 needs to be executed after step S1 and step S2 are executed.

The “first connecting plate” means one connecting plate 2 corresponding to one tab 30 on one side of the single jellyroll 3, which is used to distinguish the connecting plates 2 corresponding to both ends of the jellyroll 3.

Taking Embodiment 1 as an example, reference may be made to FIG. 17 to FIG. 21 simultaneously. First, the first plate 10 on the first corner connector 1 is connected to one terminal on the head cover sheet 40, usually by welding. Both ends of the head cover sheet 40 are respectively provided with one terminal, and it is represented that one terminal is connected herein.

After that, the jellyroll 3 is welded with the first connecting plate, and the tab 30 at one end of the jellyroll 3, that is, the first tab and the first connecting plate, are stacked on the first supporting surface. The first supporting surface may be a platform surface of one supporting table or a platform surface with bearing properties. In this embodiment, the first supporting surface may be a platform surface of a welding bench of a professional welding set. After stacking, the first tab is welded with the first connecting plate. During this welding process, the first connecting plate and the first corner connector 1 are in a separated state, so it is more flexible to weld the first tab with the first connecting plate. After welding is completed, bending is carried out.

In addition, in the above-mentioned assembly process of the jellyroll 3 and the terminal, the first connecting plate connected to the jellyroll 3 and the first corner connector 1 connected to the terminal are two separate members, so step S1 and step S2 are interchangeable, and may also be completed simultaneously.

Then, the second plate 11 of the first corner connector 1 is welded with the first connecting plate, so as to realize the electrical connection between the jellyroll 3 and the terminal.

Especially for tabs 30 on opposite sides, this method can better realize the connection between the terminal and the tab 30, and the whole battery cell is more compact in structure and has greater energy density at the same time.

Illustratively, the following will take Embodiment 1 as an example to explain in detail several situations when the number of jellyrolls 3 is one.

Referring to FIG. 26, in some embodiments, the number of jellyrolls 3 is one, and both ends of the jellyroll 3 adopt the first corner connectors 1 to realize the connection between the tab 30 and the terminal.

The first plate 10 of one first corner connector 1 is connected electrically with one terminal on the head cover sheet 40, and the first plate 10 of another first corner connector 1 is connected electrically with the other terminal on the head cover sheet 40. Then, the jellyroll 3 is laid flat, the first tab on the side wall of one side of the jellyroll 3 and the first connecting plate are stacked on one first supporting surface. The side wall of the jellyroll 3 is supported on the supporting surface, then the first tab is welded with the first connecting plate, and then the first tab is bent. A second tab on the other side of the jellyroll 3 and a second connecting plate are stacked on one bearing surface. The second tab is welded with the second connecting plate, and then the second tab is bent.

The first connecting plate and the second connecting plate at both ends of the jellyroll 3 are respectively welded with the second plates 11 in the first corner connectors 1 at both ends of the head cover sheet 40.

Specifically, a positive tab 30 is laid flat on an aluminum connecting plate 2 and welded, and a negative tab 30 is laid flat on a copper connecting plate 2 and welded. The connecting plate 2 is turned over to bend the positive and negative tabs 30, and then the connecting plate 2 is welded to the corresponding second plate 11.

The first connecting plate may be the connecting plate 2 located on the left side and the second connecting plate may be the connecting plate 2 located on the right side.

Referring to FIG. 27, in some embodiments, the number of jellyrolls 3 is one. One end of the jellyroll 3 adopts the first corner connector 1 to realize the connection between the tab 30 and the terminal, while the other end of the jellyroll 3 adopts the second corner connector 5 to realize the connection between the tab 30 and the terminal.

The first plate 10 of the first corner connector 1 is connected electrically with one terminal on the head cover sheet 40, and the third plate 50 of the second corner connector 5 is connected electrically with the other terminal on the head cover sheet 40. Then, the jellyroll 3 is laid flat, the first tab on the side wall of one side of the jellyroll 3 and the first connecting plate are stacked on one first supporting surface. The side wall of the jellyroll 3 is supported on the supporting surface, then the first tab is welded with the first connecting plate, and then the first tab is bent.

The head cover sheet 40 is placed vertically to the jellyroll 3. The (second) tab 30 on one side of the jellyroll 3 is placed on the fourth plate 51 in the second corner connector 5 and welded, and the jellyroll 3 is folded around an edge of the second tab close to the jellyroll 3 to be parallel to the head cover sheet 40.

Finally, the second plate 11 of the first corner connector 1 is welded with the first connecting plate.

Specifically, the head cover sheet 40 is arranged vertically to the jellyroll 3. The positive tab 30 of the jellyroll 3 is placed flat on the fourth plate 51 of the aluminum second corner connector 5 on the same plane as the jellyroll 3, and welded. A negative side of the jellyroll 3 is connected to the copper (first) connecting plate 2, and the jellyroll 3 is turned vertically around the positive side, so that the positive tab 30 is bent, and the jellyroll 3 is parallel to the head cover sheet 40. The (first) connecting plate 2 welded on the bent negative tab 30 is welded to the second plate 11 of the copper first corner connector 1 of the head cover 4.

Alternatively, the head cover sheet 40 is arranged vertically to the jellyroll 3. The negative tab 30 of the jellyroll 3 is placed flat on the fourth plate 51 of the copper second corner connector 5 on the same plane as the jellyroll 3 and welded. A positive side of the jellyroll 3 is connected to the aluminum (first) connecting plate 2, and the jellyroll 3 is turned vertically around the negative electrode, so that the negative tab 30 is bent, and the jellyroll 3 is parallel to the head cover sheet 40. The (first) connecting plate 2 welded on the bent positive tab 30 is welded to the second plate 11 of the aluminum first corner connector 1 of the head cover 4.

In some embodiments, the method is applied to two jellyrolls 3, and step S1 further includes connecting electrically a first plate 10 of another first corner connector 1 with another terminal on the head cover sheet 40.

Step S2 further includes stacking a second tab on a side wall of the other side of the jellyroll 3 and a second connecting plate on one supporting surface, welding the second tab with the second connecting plate, and then bending the second tab, so that the second connecting plate is parallel to the side wall on which the second tab is placed.

In step S3, the two first connecting plates welded on the two first tabs on the same side of the two jellyrolls 3 are co-welded with the second plate 11 of the first corner connector 1.

The two second connecting plates welded on the two second tabs on the other sides of the two jellyrolls 3 are co-welded with the second plate 11 of another first corner connector 1.

In some embodiments, referring to FIG. 30, both ends of two jellyrolls 3 realize the connection between the tab 30 and the terminal by using the connecting plate 2, and the tab 30 of each jellyroll 3 is separately connected to one connecting plate 2.

The first plate 10 of the first corner connector 1 is connected electrically with one terminal on the head cover sheet 40, and the first plate 10 of another first corner connector 1 is connected electrically with another terminal on the head cover sheet 40.

The same operation is carried out on the two jellyrolls 3: the jellyroll 3 is laid flat, the first tab on the side wall of one side of the jellyroll 3 and the first connecting plate are stacked on one first supporting surface. The side wall of the jellyroll 3 is supported on the supporting surface, then the first tab is welded with the first connecting plate, and then the first tab is bent. A second tab on the side wall of the other side of the jellyroll 3 and a second connecting plate are stacked on one bearing surface. The second tab is welded with the second connecting plate, and then the second tab is bent.

Then, two first connecting plates welded on the two first tabs on the same side of the two jellyrolls 3 are co-welded with the second plate 11 of one first corner connector 1, and then two second connecting plates welded on the two second tabs on the same side of the two jellyrolls 3 are co-welded with the second plate 11 of another first corner connector 1.

Based on the above situation, appropriate transformations may also be made. For example, in some embodiments, as shown in FIG. 29, one end of the two jellyrolls 3 may be the same as the above situation, that is, the two tabs 30 located on the same side are each connected to one connecting plate 2, while the other end of the two jellyrolls 3 can be connected to one relatively wide connecting plate 2 at the same time.

Illustratively, several situations when the number of jellyrolls 3 is two will be described below.

In some embodiments, the method is applied to three jellyrolls 3, and step S1 further includes connecting electrically a first plate 10 of another first corner connector 1 with another terminal on the head cover sheet 40.

Step S2 further includes stacking a second tab on a side wall of the other side of the jellyroll 3 and a second connecting plate on one supporting surface, welding the second tab with the second connecting plate, and then bending the second tab, so that the second connecting plate is parallel to the side wall on which the second tab is placed.

In step S3, the three first connecting plates welded on the three first tabs on the same side of the three jellyrolls 3 are co-welded with the second plate 11 of the first corner connector 1.

The three second connecting plates welded on the three second tabs on the other sides of the three jellyrolls 3 are co-welded with the second plate 11 of another first corner connector 1.

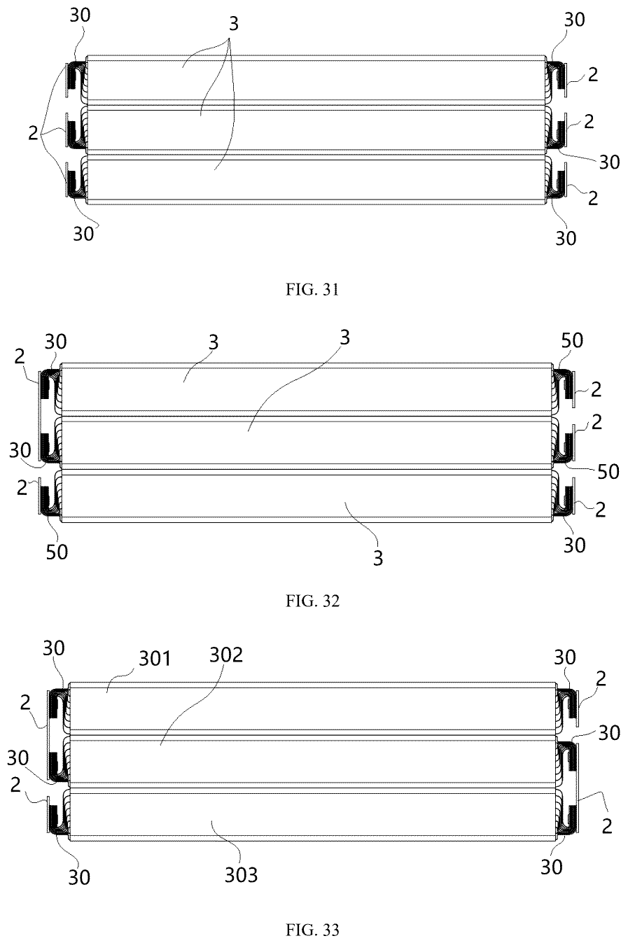

Referring to FIG. 31 for details, the number of jellyrolls 3 is three and the number of connecting plates 2 is six. Three connecting plates 2 are respectively welded with the homopolar tabs 30 on one side of the three jellyrolls 3, and the other three connecting plates 2 are welded with the homopolar tabs 30 on the other side of the three jellyrolls 3.

The first plate 10 of the first corner connector 1 is connected electrically with one terminal on the head cover sheet 40, and the first plate 10 of another first corner connector 1 is connected electrically with another terminal on the head cover sheet 40.

The same operation is carried out on the three jellyrolls 3: the jellyroll 3 is laid flat, the first tab on the side wall of one side of the jellyroll 3 and the first connecting plate are stacked on one first supporting surface. The side wall of the jellyroll 3 is supported on the supporting surface, and then the first tab is welded with the first connecting plate, and then the first tab is bent. A second tab on the side wall of the other side of the jellyroll 3 and a second connecting plate are stacked on one bearing surface. The second tab is welded with the second connecting plate, and then the second tab is bent.

Then, three first connecting plates welded on the three first tabs on the same side of the three jellyrolls 3 are co-welded with the second plate 11 of one first corner connector 1, and three second connecting plates welded on the three second tabs on the same side of the three jellyrolls 3 are co-welded with the second plate 11 of another first corner connector 1.

In some embodiments, the number of connecting plates 2 may also be five. For example, as shown in FIG. 32, the number of jellyrolls 3 is three and the number of connecting plates 2 is five. Three connecting plates are respectively welded with the homopolar tabs 30 on the same side of the three jellyrolls 3. In the other two connecting plates, one connecting plate is co-welded with the homopolar tabs 30 on the other sides of the two adjacent jellyrolls 3, and the remaining connecting plate is connected to the remaining tab 30. Moreover, the width of the connecting plate co-connected to two tabs 30 is relatively wide.

For the wider connecting plate 2, before the wider connecting plate is welded with the tabs 30 of the two jellyrolls 3, the two jellyrolls 3 are laid flat opposite to each other, and the tabs 30 are placed in the same plane with the wider connecting plate 2. Then welding is carried out. After the welding is completed, one end of the two jellyrolls 3 that are away from each other rotates toward each other, and the tab 30 welded with the wider connecting plate 2 is bent.

Then, the two jointed jellyrolls 3 are jointed to another jellyroll 3. The connecting plates 2 of the three jellyrolls 3 on the same sides are welded to the second plate 11 of one first corner connector 1, and the connecting plates 2 of the three jellyrolls 3 on the other same sides are welded to the second plate 11 of another first corner connector 1.

In some embodiments, as shown in FIG. 33, the number of jellyrolls 3 is three and the number of connecting plates 2 is four. Two connecting plates are relatively wide, and the two relatively wide connecting plates 2 are located on both sides of the jellyroll 3 respectively. The remaining two connecting plates 2 of the four connecting plates 2 are also located on both sides of the jellyroll 3 respectively.

As shown in FIG. 33, the tabs 30 at the left ends of the two jellyrolls 3 located relatively above are co-connected to one wider connecting plate 2, while the tabs 30 at the right ends of the two jellyrolls 3 located relatively lower are co-connected to another wider connecting plate 2. The left end of one jellyroll 3 located relatively below is connected to one of the two remaining connecting plates 2, and the right end of one jellyroll 3 located relatively above is connected to the other of the two remaining connecting plates 2.

In order to facilitate the description of the assembly process, the three jellyrolls 3 shown in FIG. 33 are named as the first jellyroll 301, the second jellyroll 302, and the third jellyroll 303 in order from top to bottom.

The specific assembly process may be as follows:

Process 1: stacking the tab 30 on one side of the first jellyroll 301 and one connecting plate 2 on one supporting plane and welding them, and then bending the tab 30 after welding, and performing the same operation on the tab 30 on one side of the third jellyroll 303.

Process 2: taking one jellyroll 3 with metal layers that are not pressed and molded, and pressing the metal layer on one side in a first direction to form a tab 30, and pressing the metal layer on the other side in a second direction to form a tab 30. The first direction is opposite to the second direction. The first direction is a direction to which one side of the metal layer is oriented, and the second direction is the direction to which the other side of the metal layer is oriented. This process corresponds to molding the second jellyroll 302.

Process 3: placing the first jellyroll 301 and the second jellyroll 302 on one plane to make one side of the first jellyroll 301 without welding the connecting plate 2 being opposite to one side wall in the second jellyroll 302 where the tab 30 is arranged. At the same time or before that, placing the wider connecting plate 2 on the plane, and finally stacking the tab 30 of the first jellyroll 301 without welding the connecting plate 2 and the tab 30 on one side of the second jellyroll 302 on the wider connecting plate 2 together, and welding the tab 30 of the first jellyroll 301 without welding the connecting plate 2, the tab 30 on one side of the second jellyroll 302, and the wider connecting plate 2 subsequently.

Process 4: placing the third jellyroll 303 and the second jellyroll 302 welded with the first jellyroll 301 on one plane, and making one side of the third jellyroll 303 without welding the connecting plate 2 being opposite to another side wall of the second jellyroll 302 where the tab 30 is arranged. At the same time or before that, placing another wider connecting plate 2 on the plane, and finally stacking the tab 30 of the third jellyroll 303 without welding the connecting plate and the tab 30 on the other side of the second jellyroll 302 on the wider connecting plate 2 together, and welding the tab 30 of the third jellyroll 303 without welding the connecting plate 2, the tab 30 on the other side of the second jellyroll 302, and the wider connecting plate 2 subsequently.

Process 5: (1) rotating the first jellyroll 301 around the end of the first jellyroll 301 connected to the second jellyroll 302 toward the second jellyroll 302; and

(2) rotating the third jellyroll 303 around the end of the third jellyroll 303 connected to the second jellyroll 302 toward the second jellyroll 302.

The above (1) and (2) may be carried out simultaneously or separately.

The first jellyroll 301 is rotated around the end of the first jellyroll 301 connected to the second jellyroll 302 toward the second jellyroll 302, and the third jellyroll 303 is rotated around the end of the third jellyroll 303 connected to the second jellyroll 302 toward the second jellyroll 302 simultaneously or respectively, which entirely realizes “Z”-shaped folding entirely, and finally makes the first jellyroll 301, the second jellyroll 302, and the third jellyroll 303 attached to each other.

Process 6: welding the connecting plates 2 on the same side of the first jellyroll 301, the second jellyroll 302, and the third jellyroll 303 with the two second plates 11 in the head cover sheet 40 respectively. This means that all the connecting plates 2 on the same sides are connected to the second plate 11 in one first corner connector 1, and all the connecting plates on the other same sides are connected to the second plate 11 in another first corner connector 1.

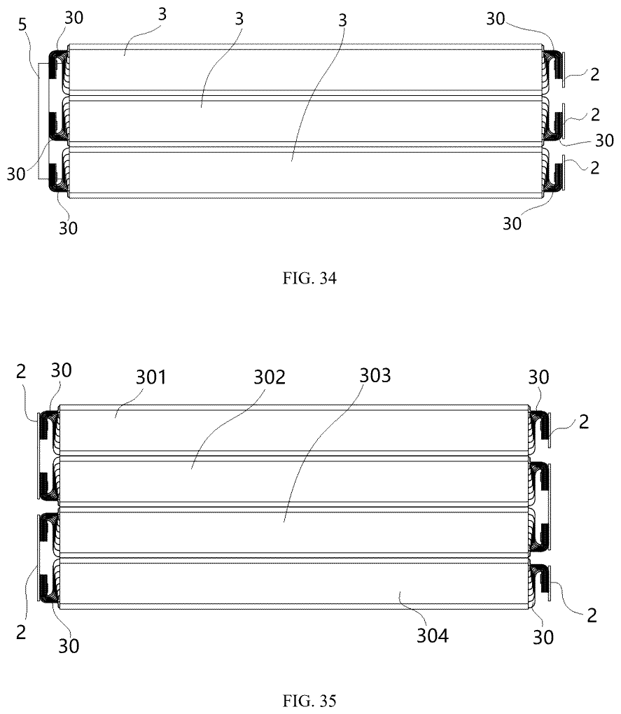

In some embodiments, as shown in FIG. 34, the number of jellyrolls 3 is three, wherein one end of the jellyroll is provided with a pin assembly and the other end of the jellyroll is provided with a second corner connector 5.

The specific assembly process may be as follows:

Process 1: stacking the first tab 30 on one side of one jellyroll 3 and one connecting plate 2 on one supporting plane and welding them, and then bending the tab 30 after welding, and performing the same operation on the tabs 30 on one side of the other two jellyrolls 3.

Process 2: placing the head cover sheet 40 vertically to two jellyrolls 3, placing one side of the two jellyrolls 3 provided with the second tabs opposite to each other, and placing the two second tabs of the two jellyrolls 3 on the fourth plate 51 of the second corner connector 5 at the same time and welding them, and then folding the two jellyrolls 3 with one side of the second tab close to the jellyroll 3 as an axis to be parallel to the head cover sheet 40. It should be added that a width of the fourth plate 51 needs to be reserved with an extra width for the second tab.

Process 3: stacking the tab 30 on one side of the remaining jellyroll 3 without welding the connecting plate 2 and the fourth plate 51 in one plane and welding them, and then rotating the jellyroll 3 toward the other two jointed jellyrolls 3 to be parallel to the head cover sheet 40.

process 4: welding three connecting plates 2 on the same side of the three jellyrolls 3 to the second plate 11.

In this process, it is preferable that the end welded to the second corner connector 5 is a positive electrode.

In some embodiments, as shown in FIG. 35, the number of jellyrolls 3 is four and the number of connecting plates 2 is five. Three connecting plates are relatively wide; the two relatively wide connecting plates 2 are located on the same side of the jellyrolls 3, and the other connecting plate is located in the middle of the other sides of the jellyrolls 3.

To facilitate the description of the assembly process, the four jellyrolls 3 shown in FIG. 35 are named as the first jellyroll 301, the second jellyroll 302, the third jellyroll 303, and the fourth jellyroll 304 in order from top to bottom.

The specific assembly process may be as follows:

Process 1: stacking the first tab on one side of the first jellyroll 301 and one connecting plate 2 on one supporting plane and welding them, and then bending the tab 30 after welding, and performing the same operation on the tab 30 on one side of the fourth jellyroll 304.

Process 2: taking one jellyroll 3 with metal layers that are not pressed and molded, and forming a tab 30 by pressing the metal layer on one side in a first direction, and forming another tab by pressing the metal layer on the other side in a second direction. The first direction is opposite to the second direction. The first direction is a direction in which one side of the metal layer is oriented, and the second direction is the direction in which the other side of the metal layer is oriented. This process corresponds to the molding of the second jellyroll 302 and the third jellyroll 303.

Process 3: placing the first jellyroll and the second jellyroll on one plane, and making one side of the first jellyroll without welding the connecting plate 2 being toward one side wall of the second jellyroll where the tab 30 is arranged. At the same time or before, place the wider connecting plate 2 on the plane. Finally, stack the tab 30 of the first jellyroll without welding the connecting plate 2 and the tab 30 on one side of the second jellyroll together on the wider connecting plate 2, and weld the tab 30 of the first jellyroll without welding the connecting plate 2, the tab 30 on one side of the second jellyroll, and the wider connecting plate 2.

Process 4 includes placing the third jellyroll 303 and the second jellyroll 302 welded with the first jellyroll 301 on one plane, and making one side of the third jellyroll 303 with the tab 30 being toward another side wall of the second jellyroll 302 with the tab 30. At the same time or before, place another wider connecting plate 2 on the plane. Finally, stack the tab 30 on the side of the third jellyroll 303 and the tab 30 on the other side of the second jellyroll 302 together on the wider connecting plate 2, and weld the tab 30 on the side of the third jellyroll 303, the tab 30 on the other side of the second jellyroll 302, and the wider connecting plate 2 subsequently.

Process 5 includes: placing the fourth jellyroll 304 and the third jellyroll 303 welded with the first jellyroll 301 and the second jellyroll 302 on one plane, and making the other side of the third jellyroll 303 with tab 30 being toward one side of the tab 30 in the fourth jellyroll 304 without welding the connecting plate 2. At the same time or before, place another wider connecting plate 2 on the plane. Finally, stack the tab 30 on the other side of the third jellyroll 303 and the tab 30 in the fourth jellyroll 304 without welding the connecting plate 2 together on the wider connecting plate 2, and weld the tab 30 on the other side of the third jellyroll 303, the tab 30 in the fourth jellyroll 304 without welding the connecting plate 2, and the wider connecting plate 2.

Process 6 includes:
(1) rotating the first jellyroll 301 around one end of the first jellyroll 301 connected with the second jellyroll 302 toward the second jellyroll 302, and causing the first jellyroll 301 being attached to the second jellyroll 302;
(2) rotating the first jellyroll 301 and the second jellyroll 302, which are attached to each other, around the ends connected to the third jellyroll 303 toward the third jellyroll 303, and attach the first jellyroll 301 and the second jellyroll 302 being attached to the third jellyroll 303; and
(3) rotating the first jellyroll 301, the second jellyroll 302, and the third jellyroll 303, which are attached to each other, around the ends connected to the fourth jellyroll 304 toward the fourth jellyroll 304, and causing the first jellyroll 301, the second jellyroll 302, and the third jellyroll 303 being attached to the fourth jellyroll 304.

Alternatively, the process includes:
(1) rotating the first jellyroll 301 around its end connected to the second jellyroll 302 toward the second jellyroll 302, and causing the first jellyroll 301 being attached to the second jellyroll 302; (this process may also be executed with the following (2) at the same time);
(2) rotating the fourth jellyroll 304 around its end connected to the third jellyroll 303 toward the third jellyroll 303, and attaching the fourth jellyroll 304 to the third jellyroll 303. (This process may also be executed with the above (1) at the same time.)
(3) a. rotating the first jellyroll 301 and the second jellyroll 302, which are attached to each other, around the end of the second jellyroll 302 connected to the third jellyroll 303 toward the third jellyroll 303 and the fourth jellyroll 304, which are attached to each other, and causing the first jellyroll 301 and the second jellyroll 302 which are attached to each other being attached to the third jellyroll 303 and the fourth jellyroll 304 which are attached to each other.

Alternatively, the process includes:
b. rotating the third jellyroll 303 and the fourth jellyroll 304, which are attached to each other, around the end of the second jellyroll 302 connected to the third jellyroll 303 toward the first jellyroll 301 and the second jellyroll 302, which are attached to each other, and causing the third jellyroll 303 and the fourth jellyroll 304 which being attached to each other.

Processes a and b are interchangeable.

Process 7 includes: welding the connecting plates 2 on the same side of the first jellyroll 301, the second jellyroll 302, the third jellyroll 303 and the fourth jellyroll 304 with the second plate 11 in one first corner connector 1, and welding the connecting plates 2 on the other sides with the second plate 11 in another first corner connector 1.

In this process, it is preferable to set one side with two wider connecting plates 2 arranged as positive electrodes, and weld the connecting plates 2 corresponding to the positive electrodes with the second plate 11 corresponding to the positive terminal preferably.

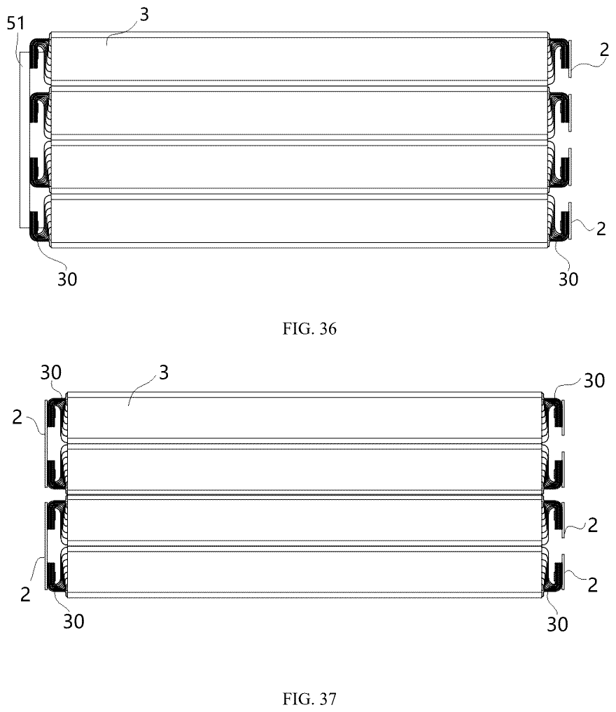

As shown in FIG. 36, the number of jellyrolls 3 is four, wherein the tabs 30 on one side of the jellyrolls 3 are connected to the head cover 4 through the first corner connector 1. The side corresponding to the four jellyrolls 3 is provided with four connecting plates 2, and the tabs 30 on the other sides are connected to the head cover 4 through the second corner connector 5.

The specific assembly process may be as follows:

Process 1: stacking the first tab 30 on one side of one jellyroll 3 and one connecting plate 2 on one supporting plane and welding them, and then bending the tab 30 after welding, and performing the same operation on the tabs 30 on one side of the other three jellyrolls 3.

Process 2: taking two jellyrolls 3 in the process 1, stacking one side of the two jellyrolls 3 without welding the connecting plates 2 and the fourth plate 51 in the second corner connector 5 together, and making the two jellyrolls 3 be in opposite states, welding the tabs 30 being stacked together with the fourth plate 51, and then, rotating the two jellyrolls 3 relatively so as to be attached to each other, and both parallel to the head cover sheet 40.

Process 3: placing the remaining two jellyrolls 3 in the process 1 on one plane, at the same time or before, placing the semi-completed products in the process 2 on the same plane vertically. And ensuring that the fourth plate 51 is stacked with the tabs 30 in the remaining jellyrolls 3 without welding the connecting plate 2 and the remaining two jellyrolls 3 are located on the two sides of the two jellyrolls 3 which are already attached to each other respectively, and the tabs 30 are located above the fourth plate 51. The two jellyrolls 3 are rotated toward and jointed to the two jellyrolls 3 formed in the process 2 respectively.

Process 4: connecting the connecting plate 2 on one side of the jellyroll 3 with the second plate 11 in the first corner connector 1.

In the present process, it is preferable that the tab 30 corresponding to the positive electrode is connected to the head cover 4 through the second corner connector 5.

In some embodiments, as shown in FIG. 37, the jellyrolls 3 are divided into two sets, and each set includes two jellyrolls 3. The tabs 30 on one side of two jellyrolls 3 in one set are correspondingly welded with one connecting plate 2, respectively, and the two tabs 30 on the other sides are co-welded with one wider connecting plate 2. The tabs 30 on one side of two jellyrolls 3 in the other set are correspondingly welded with one connecting plate 2, respectively, and the two tabs 30 on the other sides are co-welded with another wider connecting plate 2. One side of the two sets of jellyrolls 3 co-connected to one connecting plate 2 are located on the same sides.

The specific assembly process may be as follows:

Process 1: for each set of jellyrolls 3, the following operations are executed: welding the tabs 30 on one side of two jellyrolls 3 correspondingly with one connecting plate 2 respectively and bending them, then stacking the tabs 30 on one side of the two jellyrolls 3 without welding the connecting plate 2 with one wider connecting plate 2. After that, welding two tabs 30 with the wider connecting plate 2, and then folding the two jellyrolls 3 relatively, so that the two jellyrolls 3 are attached to each other.

Two sets of jellyrolls 3 are co-attached in parallel, wherein four connecting plates 2 arranged on one side are welded to the second plate 11 of one first corner connector 1, and two wider connecting plates 2 arranged on the other sides are welded to the second plate 11 of another first corner connector 1.

In the present process, the side in each set of jellyrolls 3 provided with only one connecting plate 2 is corresponding to the positive electrode, and the connecting plate 2 corresponding to the positive electrode is preferentially welded with the second plate 11 corresponding to the positive terminal.

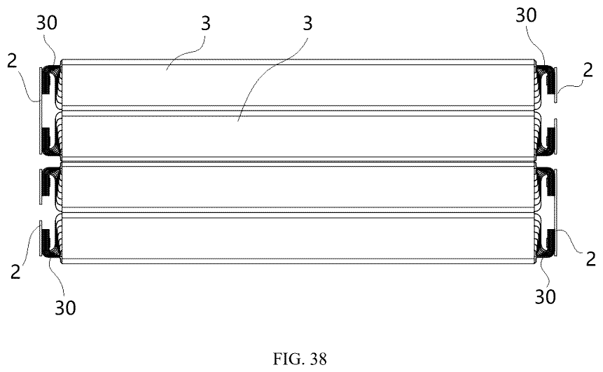

In some embodiments, modifications may also be made to the above situations. As shown in FIG. 38, the jellyrolls 3 are divided into two sets, and each set includes two jellyrolls 3. The tabs 30 on one side of two jellyrolls 3 in one set are correspondingly welded with one connecting plate 2, respectively, and the two tabs 30 on the other sides are co-welded with one wider connecting plate 2. The tabs 30 on one side of two jellyrolls 3 in the other set are correspondingly welded with one connecting plate 2, respectively, and the two tabs 30 on the other sides are co-welded with another wider connecting plate 2. One side of the two sets of jellyrolls 3 co-connected to one connecting plate 2 are located on opposite sides.

In some embodiments, the method is applied to two jellyrolls 3, and step S1 further includes connecting electrically a third plate 50 of a second corner connector 5 with one terminal on the head cover sheet 40.

Before step S3, the method further includes step S31, wherein step S31 includes: vertically placing the head cover sheet so that the fourth plate 51 of the second corner connector 5 is horizontally placed. Place one side of the two jellyrolls 3 provided with the second tabs opposite to each other, and stack the two second tabs of the two jellyrolls 3 and the fourth plate 51 of the second corner connector 5 on one second supporting surface and weld them together. Then bend the two jellyrolls 3 relative to the fourth plate 51 of the second corner connector 5 to be parallel to each other.

In step S3, the two first connecting plates welded on the two first tabs on the same side of the two jellyrolls 3 are co-welded with the second plate 11 of the first corner connector 1.

Step S31 needs to be executed after step S1 and step S2 are executed, and in some embodiments, step S31 may also be performed before step S2.

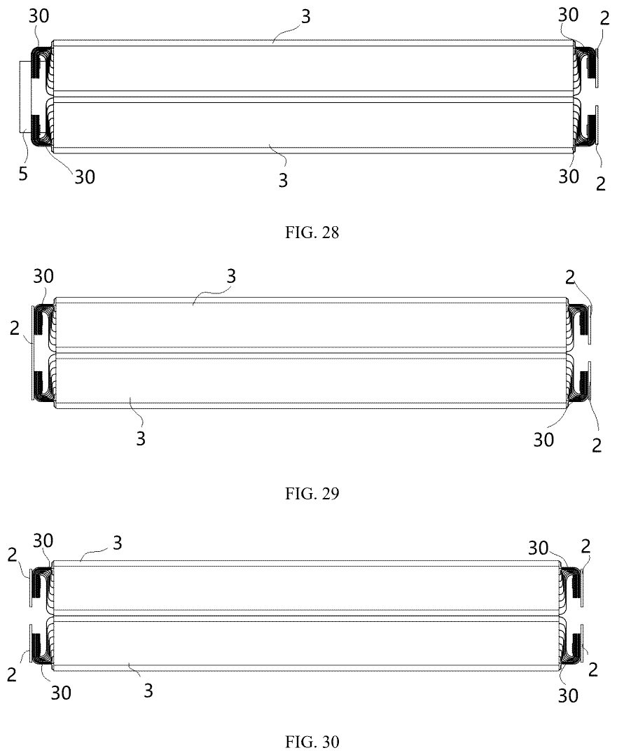

Referring to FIG. 28, in some embodiments, the number of jellyrolls 3 is two. One end of the jellyroll 3 adopts the first corner connector 1 to realize the connection between the tab 30 and the terminal, while the other end of the jellyroll 3 adopts the second corner connector 5 to realize the connection between the tab 30 and the terminal.

The first plate 10 of the first corner connector 1 is connected to one terminal on the head cover sheet 40, and the third plate 50 of the second corner connector 5 is connected electrically with another terminal on the head cover sheet 40. The two jellyrolls 3 are laid flat, the first tabs on the side walls of one side of the two jellyrolls 3 and the first connecting plate are stacked on one first supporting surface, the side walls of the jellyrolls 3 are supported on the supporting surface, and then the first tabs are welded with the first connecting plate, and then the two first tabs are bent, respectively.

The head cover sheet 40 is placed vertically to the two jellyrolls 3. One side of the two jellyrolls 3 provided with the second tabs is placed opposite each other, and the two second tabs of the two jellyrolls 3 are placed on the fourth plate 51 of the second corner connector 5 at the same time and welded, and then the two jellyrolls 3 are folded with one side of the second tab close to the jellyroll 3 as an axis to be parallel to the head cover sheet 40.

After that, the two first connecting plates welded on the two first tabs on the same side of the two jellyrolls 3 are co-welded with the second plate 11 of the first corner connector 1.

In some embodiments, in step S2, after bending the first tab, a movable gap is formed between a part of the first tab connected to the first connecting plate and the side wall on which the first tab is placed. The movable gap needs to satisfy:

In step S31, in the process of bending the two jellyrolls 3 relative to the fourth plate 51 of the second corner connector 5 to be parallel to each other, the two jellyrolls 3 do not interfere with the two first connecting plates. After the two jellyrolls 3 are rotated to be parallel to each other, the first tab is further bent so that the first connecting plate is attached to the second plate 11 ofthe first corner connector 1.

Step S31 may be executed after step S1 and step S2 are executed.

During the rotation of the two jellyrolls 3, when the rotation is about to be completed, the first connecting plate or the first tab may interfere with the second plate 11. To avoid this problem, when bending the first tab connected to the first connecting plate, a movable gap is reserved between the part of the first tab connected to the first connecting plate and the side wall on which the first tab is placed, so as to avoid interference between the first connecting plate or the first tab and the second plate 11. After the first tab is rotated in place, the first tab welded with the first connecting plate is further bent.

In some embodiments, the second supporting surface in step S31 is the same plane as the plane on which the jellyroll 3 is placed in step S2.

In an actual assembly process, the welding of the first tab and the first connecting plate, and the welding of the second tab and the fourth plate 51 may be completed on the same plane, and the two can also be welded at the same time under a specific welding set to improve assembly efficiency.

In some embodiments, the first supporting surface in step S2 is the same plane as the plane on which the jellyroll 3 is placed.

The jellyroll 3, the first tab, and the first connecting plate are all located on the same plane.

In some embodiments, before step S1, the method further includes step S11, and step S11 includes:

Forming a welding surface 110 on one side of the second plate 11 of the first corner connector away from the first plate 10 by stamping, extending the welding surface 110 to an edge of one side of the second plate 11 away from the first plate 10, and welding the welding surface 110 with the first connecting plate.

The above are only specific embodiments of the present disclosure, so that those skilled in the art can understand or realize the present disclosure. Various modifications to these embodiments will be apparent to those skilled in the art, and the generic principles defined herein may be embodied in other embodiments without departing from the spirit or scope of the present disclosure. Therefore, the present disclosure will not be limited to these embodiments shown herein but is to be in conformity with the widest scope consistent with the principles and novel features applied herein.

What is claimed is:

1. A pin assembly, comprising:
a first corner connector, wherein the first corner connector comprises a first plate and a second plate, wherein there is an included angle between the first plate and the second plate, and the first plate is used to be electrically connected to a terminal on a head cover; and
at least one connecting plate, wherein one end of the connecting plate is welded with the second plate, one side of the connecting plate toward the first plate is provided with a first welding zone, and the first welding zone is used to be welded with a tab.

2. The pin assembly according to claim 1, wherein one end of the second plate away from the first plate is provided with a connecting section, one side of the connecting section away from the first plate is recessed relative to the second plate to form a welding surface, and the welding surface is welded with one side of the connecting plate toward the first plate.

3. The pin assembly according to claim 2, wherein one side of the connecting section toward the first plate has a protrusion relative to the second plate.

4. The pin assembly according to claim 2, wherein a parallel distance from one side surface of the second plate away from the first plate to the welding surface is no less than a thickness of the connecting plate.

5. The pin assembly according to claim 1, wherein a number of the connecting plate is two, and each of the two connecting plates is respectively used to be welded with homopolar tabs on one side of two jellyrolls.

6. The pin assembly according to claim 1, wherein a number of the connecting plate is three, and each of the three connecting plates is respectively used to be welded with homopolar tabs on one side of three jellyrolls.

7. The pin assembly according to claim 6, wherein two adjacent connecting plates of the three connecting plates are integrally arranged.

8. The pin assembly according to claim 1, wherein the included angle between the first plate and the second plate is 90 degrees.

9. A head cover, comprising a pin assembly, and further comprising a head cover sheet, wherein:
the head cover sheet is provided with a first end and a second end corresponding to a terminal in a lengthwise direction, one surface of the second end is welded with one surface of the first plate away from the second plate, and the second plate is disposed on one side of the first plate away from the first end.

10. The head cover according to claim 9, wherein a number of the first corner connector is two, and one side of the first end toward the second plate and one side of the second end toward the second plate are respectively welded with the first plate of the corresponding first corner connector.

11. The head cover according to claim 10, wherein the second plate of each of the first corner connectors is welded with two connecting plates, and the two connecting plates are arranged at intervals along a width direction of the head cover sheet.

12. The head cover according to claim 11, wherein the two connecting plates welded on one first corner connector are integrally arranged.

13. The head cover according to claim 10, wherein the second plate of each of the first corner connectors is welded with three connecting plates, and the three connecting plates are arranged at intervals along a width direction of the head cover sheet.

14. The head cover according to claim 9, further comprising a second corner connector, wherein the second corner connector comprises a third plate and a fourth plate, and there is an included angle between the third plate and the fourth plate; and one side of the first end toward the second corner connector is connected to the third plate, one side of the fourth plate toward the third plate is provided with a second welding zone, and the second welding zone is used to be welded with homopolar tabs on one sides of two jellyrolls; and
the second plate is welded with two connecting plates, and the two first welding zones of the two connecting plates are used to be correspondingly welded with two tabs on the other sides of the two jellyrolls, respectively.

15. The head cover according to claim 14, wherein the second plate is welded with two connecting plates, and the two first welding zones of the two connecting plates are used to be welded correspondingly with the two tabs on the other sides of the two jellyrolls, respectively.

16. The head cover according to claim 14, wherein the second plate is welded with three connecting plates, and two first welding zones of the three connecting plates are used to be welded correspondingly with the two tabs on the other sides of the three jellyrolls, respectively.

17. The head cover according to claim 16, wherein two adjacent connecting plates of the three connecting plates are integrally arranged.

18. The head cover according to claim 14, further comprising a positive terminal and a negative terminal, wherein the positive terminal and the negative terminal are respectively arranged at the first end and the second end of the head cover sheet, the negative terminal is electrically connected to the first plate, and the positive terminal is electrically connected to the third plate.

19. The head cover according to claim 14, wherein the included angle between the third plate and the fourth plate is 90 degrees.

20. A battery cell, comprising a head cover, and further comprising a cell core, wherein the cell core comprises a jellyroll; and
one side of the jellyroll along the lengthwise direction of the head cover is provided with a tab, the tab is bent, one side of the tab away from the jellyroll is provided with a third welding zone, and the third welding zone is welded with the first welding zone of the connecting plate.

21. The battery cell according to claim 20, wherein the other side of the jellyroll along the lengthwise direction of the head cover is provided with another tab.

22. The battery cell according to claim 20, wherein one side of the jellyroll toward the head cover is provided with another tab.

23. The battery cell according to claim 21, wherein the cell core comprises two jellyrolls, and both ends of the cell core along the lengthwise direction of the head cover sheet are provided with the first corner connectors;
wherein the second plate of one first corner connector is provided with two connecting plates, the two connecting plates being correspondingly connected to two tabs on the same side of the two jellyrolls, respectively; and
wherein the second plate of another first corner connector is provided with one connecting plate, the connecting plate being connected to two tabs on the another same side of the two jellyrolls.

24. The battery cell according to claim 21, wherein the cell core comprises three jellyrolls, and both ends of the cell core along a lengthwise direction of the head cover sheet are provided with the first corner connectors;
wherein the second plate of one first corner connector is provided with three connecting plates, and the second plate of another first corner connector is provided with two connecting plates, wherein one connecting plate is co-welded with the tabs on the same side of two adjacent jellyrolls.

25. The battery cell according to claim 21, wherein the cell core comprises three jellyrolls, and both ends of the cell core along a lengthwise direction of the head cover sheet are provided with the first corner connectors;
wherein the second plate of one first corner connector is connected to two connecting plates, and one connecting plate is co-welded with the tabs on the same side of one set of two adjacent jellyrolls; and the second plate of another first corner connector is connected to two connecting plates, and one connecting plate is co-welded with the tabs on the other same side of the other set of two adjacent jellyrolls.

26. The battery cell according to claim 21, wherein the cell core comprises four jellyrolls, and both ends of the cell core along the lengthwise direction of the head cover sheet are provided with the first corner connectors;
wherein the second plate of one first corner connector is provided with two connecting plates, the two connecting plates being correspondingly welded with the two tabs on the same side of two adjacent jellyrolls, respectively; and
wherein the second plate of another first corner connector is provided with three connecting plates, and one connecting plate relative in a middle part is welded with the two tabs on the other same side of the two adjacent jellyrolls in a middle part of the four jellyrolls.

27. The battery cell according to claim 21, wherein the cell core comprises four jellyrolls, one end of the cell core along one lengthwise direction of the head cover sheet is provided with the first corner connector, and the other end of the cell core is provided with the second corner connector;
the second plate of one first corner connector is provided with four connecting plates, the four connecting plates being welded with the four tabs on the same side of the four jellyrolls, respectively; and
the fourth plate of the second corner connector is welded with the four tabs on the other same side of the four jellyrolls.

28. The battery cell according to claim 21, wherein the cell core comprises four jellyrolls, and both ends of the cell core along the lengthwise direction of the head cover sheet are provided with the first corner connectors;
wherein the second plate of one first corner connector is provided with four connecting plates, the four connecting plates being correspondingly welded with the four tabs on the same side of the four jellyrolls, respectively; and
wherein the second plate of another first corner connector is provided with two connecting plates, the two connecting plates being correspondingly welded with two tabs on the other same side of two sets of two adjacent jellyrolls, respectively.

29. The battery cell according to claim 21, wherein the cell core comprises four jellyrolls, and both ends of the cell core along the lengthwise direction of the head cover sheet are provided with the first corner connectors;
each of the two first corner connectors is provided with three connecting plates, and one connecting plate located at an edge in the three connecting plates is connected to two tabs on the same side of two adjacent jellyrolls located at an edge in the four jellyrolls; and
one of the connecting plates connecting the two tabs is connected to two adjacent jellyrolls in the four jellyrolls, and the other connecting plate is connected to the remaining two jellyrolls in the four jellyrolls.

30. The battery cell according to claim 20, further comprising a housing and an insulating plate, wherein the cell core is arranged inside the housing; and one side of the insulating plate abuts against the connecting plate and the second plate, and the other side of the insulating plate abuts against an inner wall of the housing.

31. A battery cell set, comprising a plurality of battery cells, wherein the battery cells comprise a head cover, and a cell core, wherein the cell core comprises a jellyroll; and
one side of the jellyroll along the lengthwise direction of the head cover is provided with a tab, the tab is bent, one side of the tab away from the jellyroll is provided with a third welding zone, and the third welding zone is welded with the first welding zone of the connecting plate.

32. A method for assembling battery cell, comprising:
connecting electrically a first plate of a first corner connector with one terminal on a head cover sheet;
laying a jellyroll flat, stacking a first tab on a side wall of one side of the jellyroll and a first connecting plate on one first supporting surface, welding the first tab with the first connecting plate, and then bending the first tab to make the first connecting plate be parallel to the side wall on which the first tab is placed; and
welding a second plate of the first corner connector with the first connecting plate.

33. The method for assembling the battery cell according to claim 32, applied to two jellyrolls, wherein:
the connecting electrically a first plate of a first corner connector with one terminal on a head cover sheet further comprises: connecting electrically a first plate of another first corner connector with another terminal on the head cover sheet;
after the bending the first tab to make the first connecting plate parallel to the side wall on which the first tab is placed, the method, further comprises: stacking a second tab on a side wall of the other side of the jellyroll and a second connecting plate on one supporting surface, welding the second tab with the second connecting plate, and then bending the second tab to make the second connecting plate be parallel to the side wall at which the second tab is located;
the welding of a second plate of the first corner connector with the first connecting plate further comprises: co-welding the two first connecting plates welded on the two first tabs on the same side of the two jellyrolls with the second plate of the first corner connector; and
co-welding the two second connecting plates welded on the two second tabs on the other sides of the two jellyrolls with the second plate of another first corner connector.

34. The method for assembling the battery cell according to claim 32, applied to three jellyrolls, wherein:
the connecting electrically a first plate of a first corner connector with one terminal on a head cover sheet further comprises: electrically connecting a first plate of another first corner connector with another terminal on the head cover sheet;
after bending the first tab to make the first connecting plate parallel to the side wall on which the first tab is placed, the method further comprises: stacking a second tab on a side wall of the other side of the jellyroll and a second connecting plate on one supporting surface, welding the second tab with the second connecting plate, and then bending the second tab to make the second connecting plate be parallel to the side wall at which the second tab is located;
the welding a second plate of the first corner connector with the first connecting plate further comprises: co-welding the three first connecting plates welded on the three first tabs on the same side of the three jellyrolls with the second plate of the first corner connector; and
co-welding the three second connecting plates welded on the three second tabs on the other sides of the three jellyrolls with the second plate of another first corner connector.

35. The method for assembling the battery cell according to claim 32, applied to two jellyrolls, wherein:
electrically connecting a first plate of a first corner connector to one terminal on a head cover sheet further comprises: electrically connecting a third plate of a second corner connector with one terminal on the head cover sheet;
prior to the welding a second plate of the first corner connector with the first connecting plate, the method further comprises: vertically placing the head cover sheet, so that a fourth plate of the second corner connector is horizontally located, and placing one sides of the two jellyrolls provided with the second tabs opposite to each other, and making the two second tabs of the two jellyrolls and the fourth plate of the second corner connector be stacked on one second supporting surface and welded with each other, and then bending the two jellyrolls relative to the fourth plate of the second corner connector to be parallel to each other; and
the welding of a second plate of the first corner connector with the first connecting plate further comprises co-welding the two first connecting plates welded on the two first tabs on the same side of the two jellyrolls with the second plate of the first corner connector.

36. The method for assembling the battery cell according to claim 35, the method further comprising:
after bending the first tab, forming a movable gap between a part of the first tab connected to the first connecting plate and the side wall at which the first tab is located, the movable gap satisfying:
in the process of bending the two jellyrolls relative to the fourth plate of the second corner connector to be parallel to each other, making the two jellyrolls do not interfere with the two first connecting plates, and after the two jellyrolls are rotated to be parallel to each other, further bending the first tab to make the first connecting plate be attached to the second plate of the first corner connector.

37. The method for assembling the battery cell according to claim 35, wherein the second supporting surface is the same plane as a plane at which the jellyroll is located.

38. The method for assembling the battery cell according to claim 32, wherein the first supporting surface is the same plane as a plane at which the jellyroll is located.

39. The method for assembling the battery cell according to claim 32, wherein prior to connecting electrically a first plate of a first corner connector with one terminal on a head cover sheet, the method further:
forming a welding surface on one side of the second plate of the first corner connector away from the first plate by stamping, extending the welding surface to an edge of one side of the second plate away from the first plate, and welding the welding surface with the first connecting plate.
